(19) United States
(12) Patent Application Publication
(10) Pub. No.: US 2025/0220561 A1
(43) Pub. Date: Jul. 3, 2025

(54) Ultra-Wideband Ranging Assistance for WI-FI Roaming

(71) Applicant: Cisco Technology, Inc., San Jose, CA (US)

(72) Inventors: Jerome Henry, Pittsboro, NC (US); Vinay Saini, Bangalore (IN); Robert Barton, VANCOUVER (CA)

(21) Appl. No.: 18/917,953

(22) Filed: Oct. 16, 2024

(30) Foreign Application Priority Data
Dec. 27, 2023 (IN) 202341089064

(51) Int. Cl. H04W 48/16; H04W 48/20; H04W 64/00

(52) U.S. Cl. CPC H04W 48/16; H04W 48/20; H04W 64/003

(57) ABSTRACT

Devices, networks, systems, methods, and processes for performing Ultra-Wideband (UWB) ranging to select the next optimal AP for Wi-Fi roaming are provided herein. In order to perform the UWB ranging, a client device may receive an action frame from an AP with which the client device is currently associated. The action frame may indicate the client device to perform UWB validation to one or more neighboring APs of the AP. Further, the client device may perform, based on the action frame, the UWB ranging to the neighboring APs. Furthermore, the client device may select, based on the UWB ranging, the next optimal AP among the neighboring APs that enables the client device to maintain a stable connection with a network while the client device performs the Wi-Fi roaming. Accordingly, the client device may not suffer from connection failures or connection delays while the client device performs the Wi-Fi roaming.

The present disclosure relates to wireless networks. More particularly, the present disclosure relates to performing Ultra-Wideband ranging to validate Access Point (AP) recommendations on selecting the next optimal AP for Wi-Fi roaming.

This application claims the benefit of Indian Provisional Patent Application No. 202341089064, filed Dec. 27, 2023, which is incorporated by reference herein in its entirety.

### BACKGROUND

Wi-Fi, or wireless fidelity, has become a fundamental technology in today's world, enabling wireless connectivity across a broad spectrum of devices. The significance of Wi-Fi stems from the convenience and flexibility it offers, allowing for seamless Internet access and facilitating communication, data transfer, and various online activities. As a cornerstone of connectivity in homes, businesses, public spaces, and educational institutions, Wi-Fi assists in enhancing productivity and connectivity for individuals and organizations alike.

As technology has advanced, the role of Wi-Fi has evolved to meet growing demands for faster speeds, greater bandwidth, and improved security. These increasing demands have driven the continuous development of more advanced Wi-Fi standards. As these technologies progress, there is an increasing need for updates to Wi-Fi standards and protocols to deliver enhanced performance, greater capacity, and improved efficiency. One such update pertains to Wi-Fi roaming, where users expect their devices to maintain a stable connection to a Wi-Fi network as they move between different areas. This Wi-Fi network typically involves one or more Access Points (APs) that enable Wi-Fi-compatible devices to stay connected to the Internet or communicate with other devices within the network.

Several methods have been developed to enable seamless roaming across Wi-Fi networks. These methods often involve APs signaling the presence of neighboring APs to a client device. The client device then identifies the neighboring AP with the strongest signal as the next best option for connection. However, this approach is not always reliable. For example, the identified AP might be located behind a moving user, on a lower floor, or might be a 2.4 Gigahertz (GHz) radio that the client device was trying to avoid in the first place. Although there are various techniques that assist APs in generating more intelligent neighboring lists, client devices often continue to make suboptimal decisions. As a result, Wi-Fi roaming continues to face challenges in meeting user expectations for seamless connectivity.

### SUMMARY OF THE DISCLOSURE

Systems and methods for performing Ultra-Wideband ranging to validate Access Point (AP) recommendations on selecting the next optimal AP for Wi-Fi roaming in accordance with embodiments of the disclosure are described herein. In many embodiments, a client device includes a processor and a memory communicatively coupled to the processor. The memory comprises a roaming management logic that is configured to receive an action frame configured to indicate Ultra-Wideband (UWB) validation, perform UWB ranging to one or more access points (APs) based on the action frame, and determine a set of APs from the one or more APs based on the UWB ranging. The set of APs is located ahead of the client device along a movement path of the client device. The roaming management logic is further configured to select a roaming destination AP based on the determined set of APs.

In a number of embodiments, the action frame is received from a roaming source AP currently associated with the client device.

In a variety of embodiments, the roaming management logic is further configured to transmit a roaming assistance request message to the roaming source AP and receive a roaming assistance response message from the roaming source AP based on the transmitted roaming assistance request message. The roaming assistance request message is configured to indicate support for a roaming assistant technology and the action frame is based on the indication of support for the roaming assistant technology. The roaming assistance response message is configured to indicate one or more neighboring APs.

In various embodiments, the roaming assistance request message comprises at least one of a basic service set (BSS) transition management (BTM) query or a neighbor report request, and the roaming assistance response message comprises at least one of a BTM request or a neighbor report.

In more embodiments, determining the set of APs based on the UWB ranging comprises cross-validating one or more results of the UWB ranging against data from the roaming assistance response message.

In still more embodiments, the roaming management logic is further configured to scan for one or more neighboring APs.

In yet more embodiments, the action frame comprises one or more identifiers of each of the one or more APs.

In still yet more embodiments, the one or more identifiers comprise at least one of a basic service set identifier (BSSID) or a UWB identifier.

In numerous embodiments, the action frame further comprises an indication of a set of UWB characteristics for at least one of the one or more APs.

In additional embodiments, the action frame further comprises an indication of at least one mechanism to discover a set of UWB characteristics for at least one of the one or more APs.

In still numerous embodiments, the at least one mechanism comprises at least one of probing or access network query protocol (ANQP)-based querying.

In still additional embodiments, the UWB ranging is based on a Time Difference of Arrival (TDoA).

In numerous additional embodiments, the UWB ranging to at least one of the one or more APs is performed two or more times.

In yet additional embodiments, the roaming management logic is further configured to determine the movement path of the client device relative to each of the one or more APs based on the UWB ranging.

In still yet additional embodiments, performing the UWB ranging comprises utilizing a UWB radar function.

In several embodiments, the roaming management logic is further configured to determine a line-of-sight (LoS)/non-LoS (nLoS) status relative to the client device for each of the one or more APs based on the UWB ranging.

In yet several embodiments, the roaming management logic is further configured to determine a stability status of the LoS/nLoS status for each of the one or more APs based on the UWB ranging.

In several additional embodiments, the roaming destination AP is selected further based on at least one of a Received Signal Strength Indicator (RSSI) or a Quality of Service Basic Service Set (QBSS) load of at least one AP in the determined set of APs.

In further embodiments, a network device comprises a processor, a network interface controller configured to provide access to a network, and a memory communicatively coupled to the processor. The memory comprises a roaming management logic that is configured to receive, from a client device, a roaming assistance request message is configured to indicate support for a roaming assistant technology, and transmit to the client device a roaming assistance response message based on the received roaming assistance request message and an action frame based on the indication of support for the roaming assistant technology. The roaming assistance response message is configured to indicate one or more neighboring devices of the network device and the action frame is configured to indicate UWB validation.

In yet further embodiments, a method for managing roaming in a wireless network is provided. The method comprises receiving an action frame indicating UWB validation, performing UWB ranging to one or more APs based on the action frame, determining a set of APs from the one or more APs based on the UWB ranging, and selecting a roaming destination AP based on the determined set of APs. The set of APs is located ahead of a client device along a movement path of the client device.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a schematic block diagram of a wireless local networking system in accordance with various embodiments of the disclosure;

FIG. 2 is a conceptual depiction of a communication layer architecture in accordance with various embodiments of the disclosure;

FIG. 3 is a conceptual network diagram of various environments in which a roaming management logic can operate on a plurality of network devices in accordance with various embodiments of the disclosure;

FIG. 4 is a conceptual network diagram for connecting a client device to the next optimal AP in accordance with various embodiments of the disclosure;

FIG. 5 is an action frame received by the client device in accordance with various embodiments of the disclosure;

FIG. 6 is a flowchart depicting a process for selecting a roaming destination AP in accordance with various embodiments of the disclosure;

FIG. 7 is a flowchart depicting a process for establishing an association with the roaming destination AP in accordance with various embodiments of the disclosure;

FIG. 8 is a flowchart depicting a process for transmitting the action frame in accordance with various embodiments of the disclosure;

FIG. 9 is a flowchart depicting a process for disassociating from the client device in accordance with various embodiments of the disclosure; and

FIG. 10 is a conceptual block diagram of a device suitable for configuration with the roaming management logic in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein for validating Access Point (AP) recommendations on selecting the next optimal AP for Wi-Fi roaming. As used herein, an AP may include a network device that allows one or more client devices to connect to a network (such as the Internet) or other client devices using Wi-Fi, Bluetooth, or the like. As used herein, the client device may include a mobile computing device such as a smartphone, a tablet, a laptop/notebook, a wearable device, or the like. In an example, the client device may be equipped with one or more wireless connectivity features (such as Wi-Fi, Bluetooth, or the like) to enable the client device to connect to the Internet or other client devices. Additionally, the AP and the client device may be equipped with an Ultra-Wideband (UWB) function for various applications such as location tracking, object detection, or the like. As used herein, Wi-Fi roaming may refer to a process where the client device switches its Wi-Fi connection from a first AP to a second AP while the client device roams from a physical area serviced by the first AP to a physical area serviced by the second AP.

Various embodiments are based on the recognition that the transmission of a Basic Service Set (BSS) Transition Management (BTM) request or a neighbor report to the client device may assist the client device in selecting the next optimal AP for Wi-Fi roaming. As used herein, the next optimal AP may be an AP that enables the client device to maintain a stable connection with the network while the client device attempts to move out of a physical area serviced by a currently connected AP. In an example, the BTM request or neighbor report may indicate a list of neighboring APs, among which one could potentially be the next optimal AP. More embodiments are based on the realization that the reception of the BTM request or neighbor report alone may be insufficient in selecting the next optimal AP, because the list of neighboring APs may also include a sub-optimal AP, for example, an AP located behind a moving user or on a lower floor. To this end, the present disclosure enables validation of the BTM request or neighbor report for selecting the next optimal AP. Further, the present disclosure enables utilization of the UWB functionality supported by the client device and the APs in validating the BTM request or neighbor report.

In order to utilize the UWB functionality for validating the BTM request or neighbor report, the client device may be configured to generate and transmit a roaming assistance request message to the AP. In an example, the roaming assistance request message may indicate support for a roaming assistant technology (such as the UWB functionality supported by the client device). For example, the roaming assistance request message may include a BTM query defined in the 802.11v standard or a neighbor report request defined in the 802.11k standard. Upon receiving the roaming assistance request message, the AP may be configured to generate and transmit an action frame (e.g., an enhanced BTM request or an enhanced neighbor report) to the client device. In an example, the action frame may be configured to indicate UWB validation. In order to configure the action frame to indicate the UWB validation, the AP may identify one or more neighboring APs of the AP that support the roaming assistant technology specified in the roaming assistance request message. Further, the AP may add one or more UWB information elements (IEs) indicating UWB identifiers of the neighboring APs to the action frame while generating the action frame. For example, the UWB identifier of the neighboring AP may include a Medium Access Control (MAC) address of a UWB interface of the neighboring AP.

In additional embodiments, the action frame may further include one or more connectivity IEs indicating identifiers of the neighboring APs. In an example, an identifier of the neighboring AP may include a Basic Service Set Identifier (BSSID) of the neighboring AP (e.g., a MAC address of a Wi-Fi interface of the neighboring AP), a service set identifier (SSID) of the neighboring AP (e.g., a network name of the neighboring AP), or the like. In still additional embodiments, the action frame may further include a UWB characteristic IE or a UWB characteristic discovery mechanism IE for each of the neighboring APs. The UWB characteristic IE of the neighboring AP may indicate a set of UWB characteristics of the neighboring AP. For example, the set of UWB characteristics may include a UWB channel supported by the neighboring AP, a UWB modulation scheme used by the neighboring AP, or the like. The UWB characteristic discovery mechanism IE may indicate at least one mechanism to discover the set of UWB characteristics of the neighboring AP. For example, the at least one mechanism may include a probing mechanism, an access network query protocol (ANQP)-based querying mechanism, or the like. In still yet additional embodiments, upon receiving the roaming assistance request message, the AP may be configured to generate and transmit a roaming assistance response message to the client device. In an example, the roaming assistance response message may include the BTM request or the neighbor report.

In many embodiments, upon receiving the action frame, the client device may be configured to perform UWB ranging to the neighboring APs. In order to perform the UWB ranging, the client device may identify the neighboring APs that support the UWB functionality based on the UWB IEs and the connectivity IEs included in the action frame. Further, the client device may perform the UWB ranging with the identified neighboring APs.

In many further embodiments, the client device may perform the UWB ranging with the identified neighboring APs based on a Time Difference of Arrival (TDoA) method. For example, in the TDoA method, the client device may transmit a UWB signal to the neighboring APs and determine the location of the client device by measuring the difference in arrival times of the UWB signal at the neighboring APs. Further, the client device may be configured to perform, based on the TDoA method, the UWB ranging two or more times to determine a movement path of the client device relative to each of the neighboring APs. For example, the movement path may correspond to a sequence of locations traversed by the client device over time.

In many additional embodiments, the client device may perform the UWB ranging with the identified neighboring APs by utilizing a radar function associated with the UWB functionality. For example, by utilizing the radar function, the client device may transmit a UWB signal to each of the neighboring APs and receive a reflected UWB signal from each of the neighboring APs. Further, the client device may determine a Time of Flight (ToF) associated with each of the neighboring APs based on the transmission of the UWB signal and the reception of the reflected UWB signal and determine a line-of-sight (LoS)/non-LoS (nLoS) status of each of the neighboring APs based on the determined ToF. In an example, the LoS/nLoS status of the neighboring AP may indicate whether the neighboring AP is in the LoS of the client device or not. For example, the client device may determine that the neighboring AP is in the LoS of the client device if the determined ToF associated with the neighboring AP is less than a threshold ToF. Conversely, if the determined ToF is greater than or equal to the threshold ToF, the client device may determine that the neighboring AP is not in the LoS of the client device.

Further, the client device may be configured to determine a stability status of the LoS/nLoS status of each of the neighboring APs. In order to determine the stability status of the LoS/nLoS status, the UWB ranging may be performed two or more times by utilizing the radar function. In an example, the stability status of the LoS/nLoS status may indicate whether the LoS/nLoS status is stable or not. For example, the client device may determine that the LoS/nLoS status of the neighboring AP is stable, if the result of determining the LoS/nLoS status of the neighboring AP is consistent for a specific time duration. Conversely, the client device may determine that the LoS/nLoS status of the neighboring AP is unstable, if the result of determining the LoS/nLoS status of the neighboring AP is not consistent.

In further embodiments, the client device may be configured to determine, based on one or more results of the UWB ranging, a set of APs from the neighboring APs towards which the client device is moving. For example, the one or more results of the UWB ranging may include the identifiers of the neighboring APs with which the client device performed the UWB ranging, the movement path of the client device, and/or the stability status of the LoS/nLoS status of each of the neighboring APs. In order to determine the set of APs, the client device may be configured to cross-validate the one or more results of the UWB ranging with the information included in the roaming assistance response message. In an example, the roaming assistance response message may include the connectivity IEs indicating the identifiers of the neighboring APs. In the cross-validation, the client device may determine a set of matching APs between the one or more results of the UWB ranging and the roaming assistance response message. Further, the client device may be configured to determine the set of APs from the set of matching APs.

In further additional embodiments, the client device may be configured to determine, from the set of matching APs, the set of APs based on the movement path of the client device. In an example, the client device may determine, as the set of APs, APs that are located ahead of the client device along the movement path. In still further embodiments, the client device may determine, from the set of matching APs, the set of APs based on the stability status of the LoS/nLoS status of each of the neighboring APs. In an example, APs having their stability statuses as a stable LoS may be determined as the set of APs.

In more embodiments, the client device may be configured to select a roaming destination AP from the set of APs. In order to determine the roaming destination AP, the client device may be configured to determine at least one AP metric of each of the set of APs and select the roaming destination AP from the set of APs based on the determined at least one AP metric. In an example, the client device may determine, as the roaming destination AP, an AP whose at least one AP metric is above a threshold AP metric. Additionally, or alternatively, the client device may determine, as the roaming destination AP, an AP that has the highest at least one AP metric among the set of APs. In an example, the at least one AP metric of an AP of the set of APs may include a Received Signal Strength Indicator (RSSI) associated with the AP, a Quality of Service Basic Service Set (QBSS) load associated with the AP, or the like. For example, the RSSI and/or the QBSS load associated with the AP may be determined based on probe responses or beacon responses received from the AP.

In still more embodiments, upon selecting the roaming destination AP, the client device may be configured to establish an association with the roaming destination AP. In order to establish the association with the roaming destination AP, the client device may send an association request to the roaming destination AP. For example, the association request may indicate that the client device wants to be a part of a network associated with the roaming destination AP. Upon receiving the association request, the roaming destination AP may allow the client device to join the network associated with the roaming destination AP. In an example, the roaming destination AP may be the next optimal AP that ensures the client device maintains the stable connection with the network (such as the Internet) while the client device attempts to move out of the physical area serviced by the currently connected AP.

Advantageously, transmitting the roaming assistance request message indicating the support for the UWB functionality may trigger the AP to transmit the action frame indicating the UWB validation to the client device. Further, the reception of the action frame may trigger the client device to perform the UWB ranging to the neighboring APs of the AP. Furthermore, the results of the UWB ranging may enable the client device to select the next optimal AP that ensures the client device maintains the stable connection with the network while the client device attempts to move out of the physical area serviced by the AP. Accordingly, the client device may not suffer from connection failures (or connection delays) while roaming from the physical area serviced by the AP to another physical area. Therefore, enabling the client device to seamlessly perform the roaming by suppressing the connection failures of the client device.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

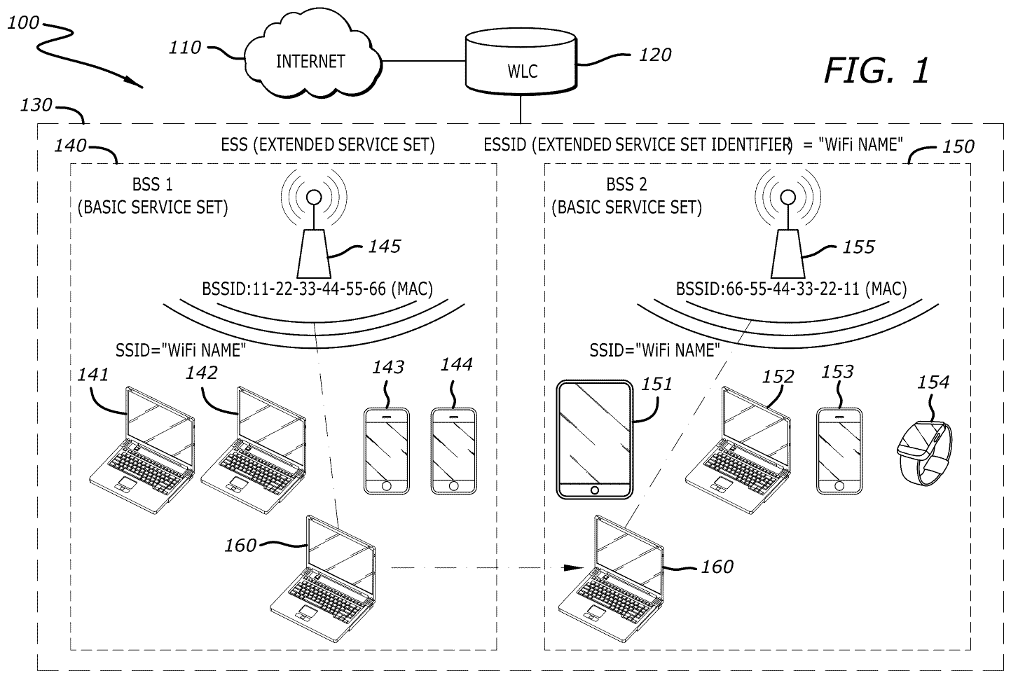

Referring to FIG. 1, a schematic block diagram of a wireless local networking system 100 in accordance with various embodiments of the disclosure is shown. Wireless local networking standards assist in enabling seamless communication and connectivity between various devices within localized areas. One of the most prevalent standards is Wi-Fi, is based on the IEEE 802.11 family of protocols. Wi-Fi provides high-speed wireless access to the internet and local network resources, with iterations such as 802.11a, 802.11b, 802.11g, 802.11n, 802.11ac, and 802.11ax, each offering improvements in speed, range, and efficiency. Each adoption of Wi-Fi standards is often designed to bring enhanced performance, increased capacity, and better efficiency in crowded network environments. Other standards can commonly be used for short-range wireless communication between devices, particularly in the realm of personal area networks (PANs). Both Wi-Fi and other protocols have become integral components of modern connectivity, supporting a wide range of devices and applications across homes, businesses, and public spaces. Emerging technologies and future iterations continue to refine wireless networking standards, ensuring the evolution of efficient, reliable, and secure wireless communication.

In the realm of IEEE 802.11 wireless local area networking standards, commonly associated with Wi-Fi technology, a service set plays a pivotal role in defining and organizing wireless network devices. A service set essentially refers to a collection of wireless devices that share a common service set identifier (SSID). The SSID, often recognizable to users as the network name presented in natural language, serves as a means of identification and differentiation among various wireless networks. Within a service set, the nodes-comprising devices like laptops, smartphones, or other Wi-Fi-enabled devices-operate collaboratively, adhering to shared link-layer networking parameters. These parameters encompass specific communication settings and protocols that facilitate seamless interaction among the devices within the service set. Essentially, a service set forms a cohesive and logical network segment, creating an organized structure for wireless communication where devices can communicate and share data within the defined parameters, enhancing the efficiency and coordination of wireless networking operations.

In the context of wireless local area networking standards, a service can be configured in two distinct forms: a basic service set (BSS) or an extended service set (ESS). A basic service set represents a subset within a service set, comprised of devices that share common physical-layer medium access characteristics. These characteristics include parameters such as radio frequency, modulation scheme, and security settings, ensuring seamless wireless networking among the devices. The basic service set is uniquely identified by a basic service set identifier (BSSID), a 48-bit label adhering to MAC-48 conventions. Despite the possibility of a device having multiple BSSIDs, each BSSID is typically associated with, at most, one basic service set at any given time.

It's crucial to note that a basic service set should not be confused with the coverage area of an access point, which is referred to as the basic service area (BSA). The BSA encompasses the physical space within which an access point provides wireless coverage, while the basic service set focuses on the logical grouping of devices sharing common networking characteristics. This distinction emphasizes that the basic service set is a conceptual grouping based on shared communication parameters, while the basic service area defines the spatial extent of an access point's wireless reach. Understanding these distinctions is fundamental for effectively configuring and managing wireless networks, ensuring optimal performance and coordination among connected devices.

The service set identifier (SSID) defines a service set or extends service set. Normally it is broadcast in the clear by stations in beacon packets to announce the presence of a network and seen by users as a wireless network name. Unlike basic service set identifiers, SSIDs are usually customizable. Since the contents of an SSID field are arbitrary, the 802.11 standard permits devices to advertise the presence of a wireless network with beacon packets. A station may also likewise transmit packets in which the SSID field is set to null; this prompts an associated access point to send the station a list of supported SSIDs. Once a device has associated with a basic service set, for efficiency, the SSID is not sent within packet headers; only BSSIDs are used for addressing.

An extended service set (ESS) is a more sophisticated wireless network architecture designed to provide seamless coverage across a larger area, typically spanning environments such as homes or offices that may be too expansive for reliable coverage by a single access point. This network is created through the collaboration of multiple access points, presenting itself to users as a unified and continuous network experience. The extended service set operates by integrating one or more infrastructure basic service sets (BSS) within a common logical network segment, characterized by sharing the same IP subnet and VLAN (Virtual Local Area Network).

The concept of an extended service set is particularly advantageous in scenarios where a single access point cannot adequately cover the entire desired area. By employing multiple access points strategically, users can move seamlessly across the extended service set without experiencing disruptions in connectivity. This is crucial for maintaining a consistent wireless experience in larger spaces, where users may transition between different physical locations covered by distinct access points.

Moreover, extended service sets offer additional functionalities, such as distribution services and centralized authentication. The distribution services facilitate the efficient distribution of network resources and services across the entire extended service set. Centralized authentication enhances security and simplifies access control by allowing users to authenticate once for access to any part of the extended service set, streamlining the user experience and network management. Overall, extended service sets provide a scalable and robust solution for ensuring reliable and comprehensive wireless connectivity in diverse and expansive environments.

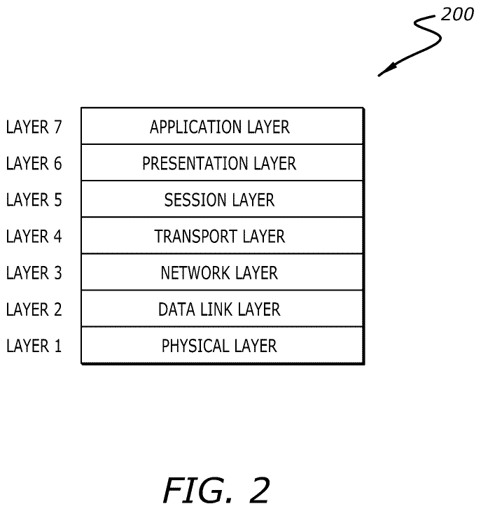

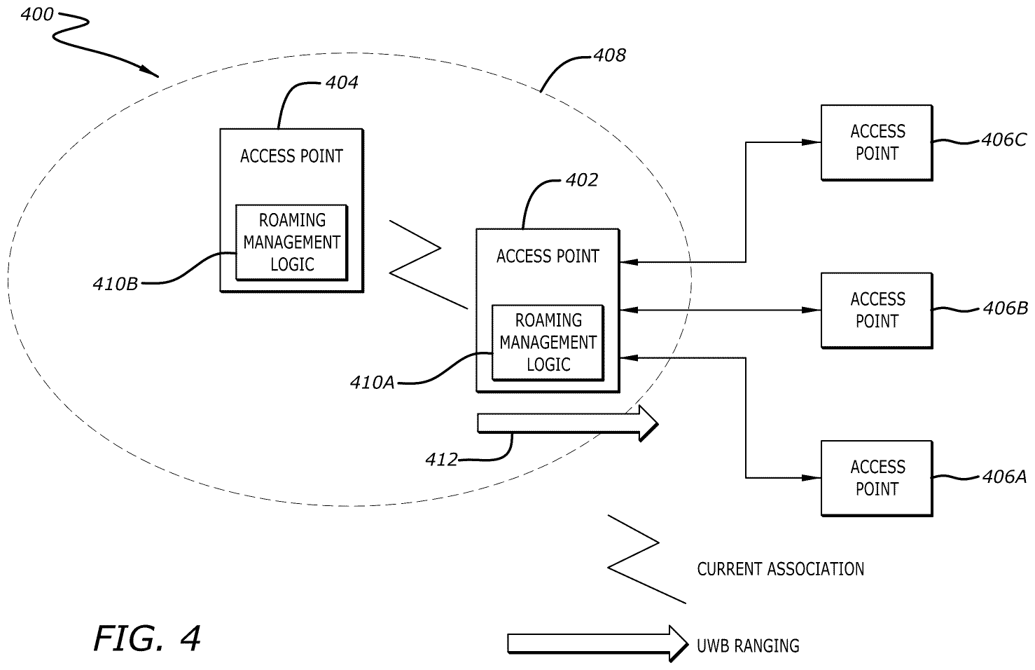

The network can include a variety of user end devices that connect to the network. These devices can sometimes be referred to as client devices or stations (i.e., “STAs”). Each device is typically configured with a medium access control (“MAC”) address in accordance with the IEEE 802.11 standard. As described in more detail in FIG. 2, a physical layer can also be configured to communicate over the wireless medium. As described in more detail in FIG. 4, various devices on a network can include components such as a processor, memory, transceiver, user interface, etc. These components can be configured to process frames of data transmitted and/or received over the wireless network. Access points (“APs”) are wireless devices configured to provide access to user end devices to a larger network, such as the Internet 110.

In the embodiment depicted in FIG. 1, a wireless network controller 120 (shown as WLC) is connected to a public network such as the Internet 110. The wireless network controller 120 is in communication with an extended service set (ESS) 130. The ESS 130 comprises two separate basic service sets (a first BSS 140 denoted as “BSS 1” and a second BSS 150 denoted as “BSS 2”). The ESS 130, the first BSS 140, and the second BSS 150 all broadcast and are configured with the same SSID “WiFi Name”, which can be a BSSID for each of the first BSS 140 and the second BSS 150 as well as an ESSID for the ESS 130.

Within the first BSS 140, the network comprises a first notebook 141, a second notebook 142, a first phone 143, a second phone 144, a first access point 145, and a third notebook 160. One or more devices among the first notebook 141, the second notebook 142, the third notebook 160, the first phone 143, and the second phone 144 may communicate with the first access point 145. Likewise, in the second BSS 150, the network comprises a tablet 151, a fourth notebook 152, a third phone 153, a watch 154, and a second access point 155. One or more devices among the tablet 151, the fourth notebook 152, the third phone 153, and the watch 154 may communicate with the second access point 155. Further, the third notebook 160 may be a part of the first BSS 140 or the second BSS 150 by being communicatively coupled to the first access point 145 or the second access point 155, respectively. In this setup, the third notebook 160 can be seen to “roam” from the physical area serviced by the first BSS 140 to the physical area serviced by the second BSS 150.

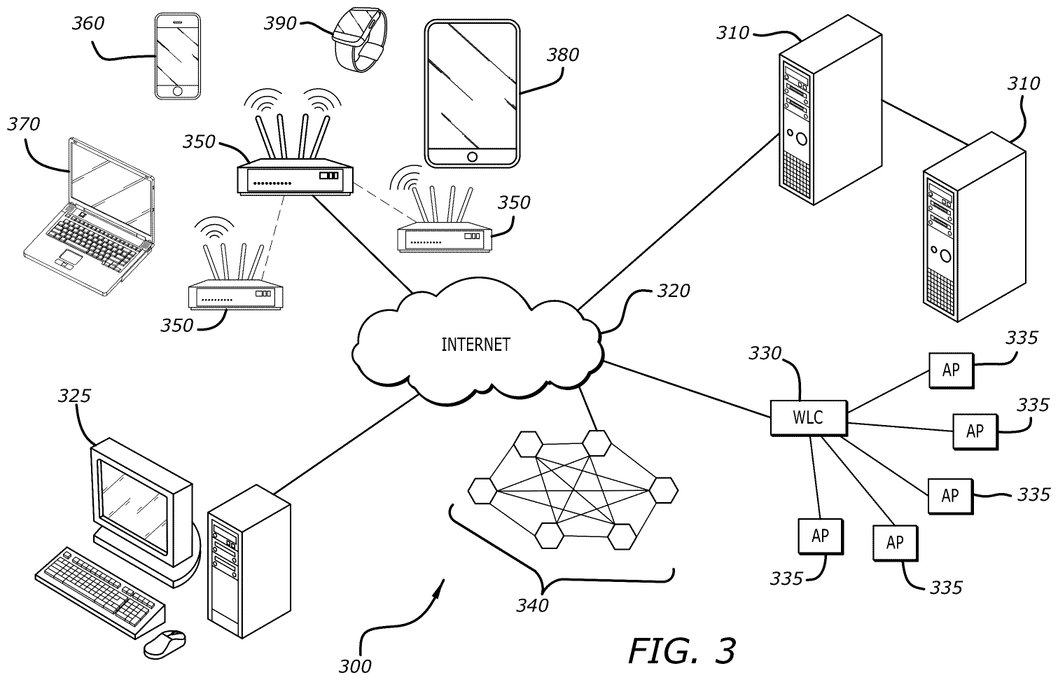

For the purpose of illustration, the ESS 130 having only two BSSs (e.g., the first BSS 140 and the second BSS 150) is shown in FIG. 1. However, the ESS 130 may include a plurality of BSSs. Various embodiments are based on a realization that the third notebook 160 may face challenges in selecting the next optimal access point while the third notebook 160 attempts to move out of the physical area serviced by a currently associated BSS. To this end, a roaming management logic is disclosed herein. In various embodiments, the roaming management logic may enable the third notebook 160 to select and connect to the next optimal access point. As used herein, the next optimal access point may be an access point that ensures the third notebook 160 maintains a stable connection with the network while the third notebook 160 attempts to move out of the physical area serviced by the currently associated BSS. The roaming management logic for selecting and connecting to the next optimal access point is explained in detail in conjunction with FIG. 3-9.

Although a specific embodiment for the wireless local networking system 100 is described above with respect to FIG. 1, any of a variety of systems and/or processes may be utilized in accordance with embodiments of the disclosure. For example, the wireless local networking system 100 may be configured into any number of various network topologies including different types of interconnected devices and user devices. The elements depicted in FIG. 1 may also be interchangeable with other elements of FIGS. 2-10 as required to realize a particularly desired embodiment.

Referring to FIG. 2, a conceptual depiction of a communication layer architecture 200 in accordance with various embodiments of the disclosure is shown. In many embodiments, the communication layer architecture 200 may be utilized to carry out various communications described or required herein. In still more embodiments, the communication layer architecture 200 may be configured as the open systems interconnection model, more commonly known as the OSI model. Likewise, the communication layer architecture 200 may have seven layers which may be implemented in accordance the OSI model.

In the embodiment depicted in FIG. 2, the communication layer architecture 200 includes a physical layer as a first layer (denoted as “Layer 1” in FIG. 2). The physical layer may serve as the foundational layer among the seven layers. The physical layer is responsible for the transmission and reception of raw, unstructured data bits over a physical medium, such as cables or wireless connections. At this layer, the focus is on the electrical, mechanical, and procedural characteristics of the hardware, including cables, connectors, and signaling. The primary goal is to establish a reliable and efficient means of physically transmitting data between devices. The physical layer does not concern itself with the meaning or interpretation of the data; instead, it concentrates on the fundamental aspects of transmitting binary information, addressing issues like voltage levels, data rates, and modulation techniques. Devices operating at the physical layer include network cables, connectors, repeaters, and hubs. The physical layer's successful operation is fundamental to the functioning of the entire OSI model, as it forms the bedrock upon which higher layers build their more complex communication protocols and structures.

In some embodiments, the communication layer architecture 200 may include a data link layer as a second layer (donated as “Layer 2” in FIG. 2). The data link layer may be configured to be primarily concerned with the reliable and efficient transmission of data between directly connected devices over a particular physical medium. Its responsibilities include framing data into frames, addressing, error detection, and, in some cases, error correction. The data link layer is divided into two sublayers: Logical Link Control (LLC) and Media Access Control (MAC). The LLC sublayer manages flow control and error checking, while the MAC sublayer is responsible for addressing devices on the network and controlling access to the physical medium. Ethernet is a common example of a data link layer protocol. This layer ensures that data is transmitted without errors and manages the flow of frames between devices on the same local network. Bridges and switches operate at the data link layer, making forwarding decisions based on MAC addresses. Overall, the data link layer plays a crucial role in creating a reliable point-to-point or point-to-multipoint link for data transmission between neighboring network devices.

In various embodiments, the communication layer architecture 200 may include a network layer as a third layer (denoted as “Layer 3” in FIG. 2). The network layer may be configured as a pivotal component responsible for the establishment of end-to-end communication across interconnected networks. Its primary functions include logical addressing, routing, and the fragmentation and reassembly of data packets. The network layer ensures that data is efficiently directed from the source to the destination, even when the devices are not directly connected. IP (Internet Protocol) is a prominent example of a network layer protocol. Devices known as routers operate at this layer, making decisions on the optimal path for data to traverse through a network based on logical addressing. The network layer abstracts the underlying physical and data link layers, allowing for a more scalable and flexible communication infrastructure. In essence, it provides the necessary mechanisms for devices in different network segments to communicate, contributing to the end-to-end connectivity that is fundamental to the functioning of the internet and other large-scale networks.

In additional embodiments, the communication layer architecture 200 may include a transport layer as a fourth layer (denoted as “Layer 4” in FIG. 2). The transport layer may be a critical element responsible for the end-to-end communication and reliable delivery of data between devices. Its primary objectives include error detection and correction, flow control, and segmentation and reassembly of data. Two key transport layer protocols are Transmission Control Protocol (TCP) and User Datagram Protocol (UDP). TCP ensures reliable and connection-oriented communication by establishing and maintaining a connection between sender and receiver, and it guarantees the orderly and error-free delivery of data through mechanisms like acknowledgment and retransmission. UDP, on the other hand, offers a connectionless and more lightweight approach suitable for applications where speed and real-time communication take precedence over reliability. The transport layer shields the upper-layer protocols from the complexities of the network and data link layers, providing a standardized interface for applications to send and receive data, making it a crucial facilitator for efficient, end-to-end communication in networked environments.

In further embodiments, the communication layer architecture 200 may include a session layer as a fifth layer (denoted as “Layer 5” in FIG. 2). The session layer may be configured to play a pivotal role in managing and controlling communication sessions between applications. It provides mechanisms for establishing, maintaining, and terminating dialogues or connections between devices. The session layer helps synchronize data exchange, ensuring that information is sent and received in an orderly fashion. Additionally, it supports functions such as checkpointing, which allows for the recovery of data in the event of a connection failure, and dialog control, which manages the flow of information between applications. While the session layer is not as explicitly implemented as lower layers, its services are crucial for maintaining the integrity and coherence of data during interactions between applications. By managing the flow of data and establishing the context for communication sessions, the session layer contributes to the overall reliability and efficiency of data exchange in networked environments.

In still further embodiments, the communication layer architecture 200 may include a presentation layer as a sixth layer (denoted as “Layer 6” in FIG. 2). The presentation layer may focus on the representation and translation of data between the application layer and the lower layers of the network stack. It can deal with issues related to data format conversion, ensuring that information is presented in a standardized and understandable manner for both the sender and the receiver. The presentation layer is often responsible for tasks such as data encryption and compression, which enhance the security and efficiency of data transmission. By handling the transformation of data formats and character sets, the presentation layer facilitates seamless communication between applications running on different systems. This layer may then abstract the complexities of data representation, enabling applications to exchange information without worrying about differences in data formats. In essence, the presentation layer plays a crucial role in ensuring interoperability and data integrity between diverse systems and applications within a networked environment.

In numerous embodiments, the communication layer architecture 200 may include an application layer as a seventh layer (denoted as “Layer 7” in FIG. 2). The application layer may serve as the interface between the network and the software applications that end-users interact with. It can provide a platform-independent environment for communication between diverse applications and ensures that data exchange is meaningful and understandable. The application layer can encompass a variety of protocols and services that support functions such as file transfers, email, remote login, and web browsing. It acts as a mediator, allowing different software applications to communicate seamlessly across a network. Some well-known application layer protocols include HTTP (Hypertext Transfer Protocol), FTP (File Transfer Protocol), and SMTP (Simple Mail Transfer Protocol). In essence, the application layer enables the development of network-aware applications by defining standard communication protocols and offering a set of services that facilitate robust and efficient end-to-end communication across networks.

Although a specific embodiment for the communication layer architecture 200 is described above with respect to FIG. 2, any of a variety of systems and/or processes may be utilized in accordance with embodiments of the disclosure. For example, various aspects described herein may reside or be carried out on one layer, or a plurality of layers. The elements depicted in FIG. 2 may also be interchangeable with other elements of FIG. 1 and FIGS. 3-10 as required to realize a particularly desired embodiment.

Referring to FIG. 3, a conceptual network diagram 300 of various environments in which a roaming management logic can operate on a plurality of network devices in accordance with various embodiments of the disclosure is shown. Those skilled in the art will recognize that the roaming management logic may include various hardware and/or software deployments and may be configured in a variety of ways. In many embodiments, the roaming management logic may be configured as a standalone device, exist as a logic in another network device, be distributed among various network devices operating in tandem, or be remotely operated as part of a cloud-based network management tool. In further embodiments, one or more servers 310 may be configured with the roaming management logic or may otherwise operate as the roaming management logic. In many further embodiments, the roaming management logic may operate on the one or more servers 310 connected to a communication network 320 (e.g., the “Internet”). The communication network 320 may include wired networks or wireless networks. The roaming management logic may be provided as a cloud-based service that may service remote networks, such as, but not limited to a deployed network 340.

However, in additional embodiments, the roaming management logic may be operated as a distributed logic across multiple network devices. In the embodiment depicted in FIG. 3, a plurality of APs 350 may operate as the roaming management logic in a distributed manner or may have one specific device operate as the roaming management logic for all of the neighboring or sibling APs 350. The APs 350 may facilitate Wi-Fi connections for various electronic devices, such as but not limited to, client devices 360-390 including laptop computers 370, cellular phones 360, portable tablet computers 380, and wearable computing devices 390. In still additional embodiments, at least one client device of the client devices 360-390 may be configured with the roaming management logic or may otherwise operate as the roaming management logic.

In numerous embodiments, the roaming management logic may be integrated within another network device. In an example, a wireless LAN controller (WLC) 330 may be configured with the roaming management logic or may otherwise operate as the roaming management logic. The WLC 330 may control operations associated with a set of APs 335 that are connected, either wired or wirelessly, to the WLC 330. In more embodiments, a personal computer 325 may be utilized to access and/or manage various aspects of the roaming management logic, either remotely or within the network itself. In the embodiment depicted in FIG. 3, the personal computer 325 communicates over the communication network 320 and may access the roaming management logic of the servers 310, the APs 350, at least one client device of the client devices 360-390, or the WLC 330.

Although a specific embodiment for various environments that the roaming management logic may operate on a plurality of network devices suitable for carrying out the various steps, processes, methods, and operations described herein is discussed with respect to FIG. 3, any of a variety of systems and/or processes may be utilized in accordance with embodiments of the disclosure. In many non-limiting examples, the roaming management logic may be provided as a device or software separate from the APs 350 or the roaming management logic may be integrated into the APs 350. The elements depicted in FIG. 3 may also be interchangeable with other elements of FIGS. 1-2 and FIGS. 4-10 as required to realize a particularly desired embodiment.

Referring to FIG. 4, a conceptual network diagram 400 for connecting a client device 402 to the next optimal AP in accordance with various embodiments of the disclosure is shown. In the embodiments shown in FIG. 4, the conceptual network diagram 400 may include the client device 402, an AP 404 to which the client device 402 is currently associated, and a plurality of APs 406A-406C which are neighbors of the AP 404. The client device 402 may include a mobile computing device such as a smartphone, a tablet, a laptop/notebook, a wearable device, a gaming console, an entertainment device, or the like. In an example, the client device 402 may be equipped with one or more wireless connectivity features (such as Wi-Fi, Bluetooth, or cellular networks) to enable the client device 402 to connect to the Internet or other client devices. Additionally, the client device 402 may be equipped with an Ultra-Wideband (UWB) function for various applications such as location tracking, object detection, or the like.

In a number of embodiments, the AP 404 may include a network device that allows one or more client devices (such as the client device 402) to connect to the Internet or other client devices using Wi-Fi, Bluetooth, or the like. Specifically, the AP 404 may allow the client device 402 to connect to the Internet or other client devices when the client device 402 is located within a cell 408 of the AP 404. In an example, the cell 408 may define a specific geographical area serviced by the AP 404. Additionally, the AP 404 may be equipped with the UWB function or may be associated with a UWB device (e.g., a UWB dongle) that supports the UWB function.

In numerous embodiments, each of the client device 402 and the AP 404 may include a processor and a memory communicatively coupled to the processor. The processor may include suitable logic, circuitry, and interfaces that are configured to execute instructions stored in the memory. For example, the processor may correspond to an application-specific integrated circuit (ASIC) processor, a complex instruction set computing (CISC) processor, a central processing unit (CPU), an explicitly parallel instruction computing (EPIC) processor, a very long instruction word (VLIW) processor, and/or other processors or circuits. The memory may comprise suitable logic, circuitry, and interfaces that are configured to store a machine code and/or the instructions executable by the processor. For example, the memory may correspond to random access memory (RAM), read only memory (ROM), electrically erasable programmable read-only memory (EEPROM), hard disk drive (HDD), a solid-state drive (SSD), a CPU cache, and/or a secure digital (SD) card.

In numerous additional embodiments, each of the client device 402 and the AP 404 may include a communication interface that is communicatively coupled to the processor and/or the memory. The communication interface may comprise suitable logic, circuitry, and interfaces that are configured to allow a device (such as the client device 402 or the AP 404) to interact with other devices. For example, the communication interface may correspond to a Wi-Fi interface, a Bluetooth interface, a UWB interface, or the like. Additionally, the AP 404 may include a network interface controller that includes suitable logic, circuitry, and interfaces configured to provide access to a network (such as the Internet). It will be understood by a person of ordinary skill in the art that each of the plurality of APs 406A-406C may be functionally and/or structurally similar to the AP 404.

In a variety of embodiments, the client device 402 and the AP 404 may be provided with a roaming management logic 410A and a roaming management logic 410B, respectively. The roaming management logic 410A may be embodied in the memory of the client device 402 or in the processor of the client device 402, or embodied as a standalone unit in the client device 402. Similarly, the roaming management logic 410B may be embodied in the memory of the AP 404 or in the processor of the AP 404, or embodied as a standalone unit in the AP 404.

In operation, the roaming management logic 410A may be configured to establish an association with the AP 404 when the client device 402 is in the vicinity of the AP 404. In order to establish the association with the AP 404, the roaming management logic 410A may transmit an authentication request to the AP 404. For example, the authentication request may include an open system authentication request or a pre-shared key (PSK) authentication request. Upon receiving the authentication request, the roaming management logic 410B may authenticate the client device 402 based on the received authentication request. After the successful authentication, the roaming management logic 410B may send an authentication response indicating an authentication successful message to the client device 402. Upon receiving the authentication response, the roaming management logic 410A may send an association request to the AP 404. In an example, the association request may indicate that the client device 402 wants to be a part of a network associated with the AP 404. Upon receiving the association request, the roaming management logic 410B may allow the client device 402 to join the network. Additionally, the client device 402 and the AP 404 may perform a handshake protocol (for example, a 4-way Handshake protocol) to establish a secure connection between the client device 402 and the AP 404.

Upon establishing the association with the AP 404, the roaming management logic 410A may be configured to monitor one or more signal metrics associated with a wireless signal of the AP 404 to determine a roaming status of the client device 402. For example, the one or more signal metrics may include a Received Signal Strength Indicator (RSSI) value associated with the wireless signal, a Signal-to-Noise Ratio (SNR) value associated with the wireless signal, or the like. In an example, the roaming status of the client device 402 may indicate whether the client device 402 is roaming towards an edge of the cell 408 or not. For example, the roaming management logic 410A may determine that the client device 402 is roaming towards the edge of the cell 408 when the one or more signal metrics fall below a threshold signal metric. Conversely, when the one or more signal metrics do not fall below the threshold signal metric, the client device 402 may determine that the client device 402 is not roaming towards the edge of the cell 408.

In many embodiments, when the roaming status of the client device 402 indicates that the client device 402 is roaming towards the edge of the cell 408, the roaming management logic 410A may be configured to generate a roaming assistance request message. In an example, the roaming assistance request message may be a request for receiving information regarding neighboring APs of the AP 404. For example, the roaming assistance request message may include at least one of a BSS Transition Management (BTM) query defined in the 802.11v standard or a neighbor report request defined in the 802.11k standard.

In many additional embodiments, the roaming assistance request message may be configured to indicate support for a roaming assistant technology. In order to configure the roaming assistance request message to indicate the support for the roaming assistant technology, the roaming management logic 410A may be configured to generate and add an Information Element (IE) indicating the support for the roaming assistant technology to the roaming assistance request message while generating the roaming assistance request message. In an example, the roaming assistant technology may include the UWB technology supported by the client device 402. In many further embodiments, when the roaming status of the client device 402 indicates that the client device 402 is roaming towards the edge of the cell 408, the roaming management logic 410A may identify the AP 404 to which the client device 402 is currently connected as a roaming source AP. Hereinafter, the AP 404 may be referred to as a roaming source AP 404. Upon generating the roaming assistance request message, the roaming management logic 410A may be configured to transmit the roaming assistance request message to the roaming source AP 404.

In more embodiments, upon receiving the roaming assistance request message, the roaming management logic 410B may be configured to generate a roaming assistance response message that is configured to indicate one or more neighboring APs of the roaming source AP 404. Specifically, the roaming management logic 410B may generate the roaming assistance response message that includes a plurality of connectivity IEs indicating a plurality of identifiers of the plurality of APs 406A-406C. In an example, an identifier of an AP of the plurality of APs 406A-406C may include a BSSID of the AP (e.g., a MAC address of the Wi-Fi interface of the AP), an SSID of the AP (e.g., a network name of the AP), or the like. For example, the roaming assistance response message may correspond to at least one of a BTM request defined in the 802.11v standard or a neighbor report defined in the 802.11k standard. Upon generating the roaming assistance response message, the roaming management logic 410B may be configured to transmit the roaming assistance response message to the client device 402.

In some more embodiments, upon receiving the roaming assistance request message, the roaming management logic 410B may be further configured to generate an action frame based on the IE included in the roaming assistance request message. For example, when the received roaming assistance request message includes the IE indicating the support for the roaming assistant technology (e.g., the UWB technology), the roaming management logic 410B may determine whether one or more neighboring APs of the roaming source AP 404 support the same roaming assistant technology. If the one or more neighboring APs (e.g., one or more APs of the plurality of APs 406A-406C) support the same roaming assistant technology, the roaming management logic 410B may generate the action frame that is configured to indicate a roaming assistant technology validation.

In an example, the roaming management logic 410B may generate the action frame that is configured to indicate UWB validation. In order to configure the action frame to indicate the UWB validation, the roaming management logic 410B may generate the action frame that includes one or more UWB IEs indicating one or more UWB identifiers of the one or more neighboring APs that support the roaming assistant technology. In the embodiments shown in FIG. 4, since all the plurality of APs 406A-406C support the roaming assistant technology, the roaming management logic 410B may generate the action frame that includes a plurality of UWB IEs indicating a plurality of UWB identifiers of the plurality of APs 406A-406C. In an example, a UWB identifier of an AP of the plurality of APs 406A-406C may include a MAC address of the UWB interface of the AP or a MAC address of the UWB device connected to the AP. Additionally, the action frame may include the plurality of connectivity IEs indicating the plurality of identifiers of the plurality of APs 406A-406C.

In yet more embodiments, the action frame may further include a plurality of UWB characteristic IEs, where each UWB characteristic IE indicates a set of UWB characteristics of a respective AP of the plurality of APs 406A-406C. In an example, the set of UWB characteristics of an AP of the plurality of APs 406A-406C may include a UWB channel supported by the AP, a UWB modulation scheme used by the AP, or the like. Additionally, or alternatively, the action frame may further include a plurality of UWB characteristic discovery mechanism IEs, where each UWB characteristic discovery mechanism IE indicates at least one mechanism to discover the set of UWB characteristics of the respective AP of the plurality of APs 406A-406C. In an example, the at least one mechanism may include a probing mechanism, an access network query protocol (ANQP)-based querying mechanism, or the like. Upon generating the action frame, the roaming management logic 410B may be configured to transmit the action frame to the client device 402.

In still more embodiments, the client device 402 may be provided with a connectivity stack and a UWB stack to support at least one wireless connectivity function (such as Wi-Fi, Bluetooth, or the like) and the UWB function, respectively. For example, each of the connectivity stack and the UWB stack may be structurally and/or functionally similar to the communication layer architecture 200 described in the detailed description of FIG. 2. In an example, by utilizing specifications such as Fine Ranging (FiRa), Omlox, or the like, the UWB function support by the UWB stack may be connected to or associated with the connectivity stack. Specifically, the UWB function may be associated with an upper layer (e.g., Layer 2) of the connectivity stack.

In still yet more embodiments, upon receiving the action frame from the roaming source AP 404, the roaming management logic 410A may be configured to perform the UWB validation. In order to perform the UWB validation, the roaming management logic 410A may be configured to perform UWB ranging to the plurality of APs 406A-406C based on the received action frame. For example, to perform the UWB ranging, the roaming management logic 410A may query the UWB function associated with the connectivity stack by utilizing information (e.g., the plurality of UWB IEs) included in the action frame. In an example, the UWB function may be queried with the plurality of UWB IEs in anticipation of updating the UWB stack with the plurality of UWB IEs. Further, the roaming management logic 410A may perform the UWB ranging to the plurality of APs 406A-406C by utilizing the updated UWB stack.

In several embodiments, the roaming management logic 410A may perform, by utilizing the updated UWB stack, the UWB ranging to the plurality of APs 406A-406C based on a Time Difference of Arrival (TDoA) method. For example, based on the TDoA method, the roaming management logic 410A may transmit a UWB signal to the plurality of APs 406A-406C and determine the location of the client device 402 by measuring the difference in arrival times of the UWB signal at the plurality of APs 406A-406C. Additionally, the roaming management logic 410A may be configured to determine a movement path 412 of the client device 402 relative to each of the plurality of APs 406A-406C. In order to determine the movement path 412 of the client device 402, the UWB ranging may performed two or more times based on the TDoA method. For example, the movement path 412 may correspond to a sequence of locations traversed by the client device 402 over time. In an example, the movement path 412 may be utilized to determine whether the client device is moving towards a given AP or not. Upon determining the movement path 412, the roaming management logic 410A may control the updated UWB stack to feed, as a result of the UWB ranging, information indicating the determined movement path 412 to the UWB function associated with the connectivity stack.

In several more embodiments, the roaming management logic 410A may be further configured to determine a line-of-sight (LoS)/non-LoS (nLoS) status of each of the plurality of APs 406A-406C. In order to determine the LoS/nLoS status of each of the plurality of APs 406A-406C, the roaming management logic 410A may utilize a radar function associated with the UWB function to perform the UWB ranging to the plurality of APs 406A-406C. For example, by utilizing the radar function associated with the UWB function, the roaming management logic 410A may transmit a UWB signal to each of the plurality of APs 406A-406C and receive a reflected UWB signal from each of the plurality of APs 406A-406C. Further, the roaming management logic 410A may determine a Time of Flight (ToF) associated with each of the plurality of APs 406A-406C based on the transmission of the UWB signal and the reception of the reflected UWB signal and determine the LoS/nLoS status of each of the plurality of APs 406A-406C based on the determined ToF. In an example, the LoS/nLoS status of a particular AP may indicate whether the particular AP is in the LoS of the client device 402 or not. For example, the roaming management logic 410A may determine that the particular AP is in the LoS of the client device 402 if the determined ToF associated with the particular AP is less than a threshold ToF. Conversely, if the determined ToF associated with the particular AP is greater than or equal to the threshold ToF, the roaming management logic 410A may determine that the particular AP is not in the LoS of the client device 402. Upon determining the LoS/nLoS status of each of the plurality of APs 406A-406C, the roaming management logic 410A may control the updated UWB stack to feed, as a result of the UWB ranging, information indicating the LoS/nLoS status of each of the plurality of APs 406A-406C to the UWB function.

Additionally, the roaming management logic 410A may be further configured to determine a stability status of the LoS/nLoS status of each of the plurality of APs 406A-406C. In order to determine the stability status of the LoS/nLoS status, the UWB ranging may be performed two or more times by utilizing the radar function. In an example, the stability status of the LoS/nLoS status may indicate whether the LoS/nLoS status is stable or not. For example, the roaming management logic 410A may determine that the LoS/nLoS status of the particular AP is stable, if the result of determining the LoS/nLoS status of the particular AP is consistent for a specific time duration. Conversely, the roaming management logic 410A may determine that the LoS/nLoS status of the particular AP is unstable, if the result of determining the LoS/nLoS status of the particular AP is not consistent. In an example, the roaming management logic 410A may determine that the LoS/nLoS status of the particular AP is unstable, if the LoS/nLoS status indicates that the particular AP is in the LoS of the client device 402 in a first attempt of the UWB ranging and further the LoS/nLoS status indicates that the particular AP is not in the LoS of the client device 402 in a second attempt of the UWB ranging. Upon determining the stability status of the LoS/nLoS status, the roaming management logic 410A may control the updated UWB stack to feed, as a result of the UWB ranging, information indicating the stability status of the LoS/nLoS status of each of the plurality of APs 406A-406C to the UWB function.

In further embodiments, the roaming management logic 410A may be further configured to determine, based on the UWB ranging, a set of APs from the plurality of APs 406A-406C towards which the client device 402 is moving. Specifically, the roaming management logic 410A may determine the set of APs based on one or more results of the UWB ranging. In an example, the one or more results of the UWB ranging may include the plurality of identifiers of the plurality of APs 406A-406C with which the client device 402 performed the UWB ranging, the determined movement path 412 of the client device 402 relative to each of the plurality of APs 406A-406C, the LoS/nLoS status of each of the plurality of APs 406A-406C, and/or the stability status of the LoS/nLoS status of each of the plurality of APs 406A-406C.

In still further embodiments, to determine the set of APs, the roaming management logic 410A may be configured to cross-validate the one or more results of the UWB ranging with data included in the roaming assistance response message. In an example, the roaming assistance response message may include the plurality of connectivity IEs indicating the plurality of identifiers of the plurality of APs 406A-406C. In the cross-validation, the roaming management logic 410A may determine a set of matching APs between the one or more results of the UWB ranging and the roaming assistance response message. In the embodiments shown in FIG. 4, the roaming management logic 410A may determine all the plurality of APs 406A-406C as the set of matching APs since the plurality of identifiers indicated by the one or more results of the UWB ranging and the plurality of identifiers indicated by the roaming assistance response message are the same. Additionally, or alternatively, the roaming management logic 410A may be configured to perform scanning to identify neighboring APs of the roaming source AP 404. For example, the scanning may correspond to active scanning where the roaming management logic 410A sends probe requests to identify the neighboring APs, or passive scanning where the roaming management logic 410A listens for beacon frames sent by the neighboring APs. Further, the roaming management logic 410A may perform the cross-validation to determine the set of matching APs between the identified neighboring APs and the plurality of APs 406A-406C with which the client device 402 performed the UWB ranging. Further, the roaming management logic 410A may determine, from the set of matching APs, the set of APs towards which the client device 402 is moving.

In further additional embodiments, the roaming management logic 410A may determine, from the set of matching APs, the set of APs towards which the client device 402 is moving based on the determined movement path 412 of the client device 402. In an example, the roaming management logic 410A may determine, as the set of APs towards which the client device 402 is moving, APs that are located ahead of the client device 402 along the movement path 412. In the embodiments shown in FIG. 4, the roaming management logic 410A may determine the set of APs as the APs 406A and 406B since the APs 406A and 406B are located ahead of the client device 402 along the movement path 412. Additionally, or alternatively, the roaming management logic 410A may determine the set of APs based on the stability status of the LoS/nLoS status of each of the plurality of APs 406A-406C. In an example, the roaming management logic 410A may determine, as the set of APs towards which the client device 402 is moving, APs having their stability statuses as a stable LoS.

In additional embodiments, the roaming management logic 410A may be configured to select, from the determined set of APs, a roaming destination AP for the client device 402. In order to select the roaming destination AP from the set of APs, the roaming management logic 410A may be configured to execute a roaming algorithm. In an example, the roaming algorithm may be a Machine Learning (ML) model or a neural network (NN) that is pre-trained to select the roaming destination AP from the set of APs. Upon the execution of the roaming algorithm, the roaming management logic 410A may determine at least one AP metric of each of the set of APs and select the roaming destination AP from the set of APs based on the determined at least one AP metric. In an example, the roaming management logic 410A may determine, as the roaming destination AP, an AP whose at least one AP metric is above a threshold AP metric. Additionally, or alternatively, the roaming management logic 410A may determine, as the roaming destination AP, an AP that has the highest at least one AP metric among the set of APs. In an example, the at least one AP metric of an AP of the set of APs may include a RSSI associated with the AP, a Quality of Service Basic Service Set (QBSS) load associated with the AP, or the like. For example, the RSSI and/or the QBSS load associated with the AP may be determined based on probe responses or beacon responses received from the AP.

In still additional embodiments, upon selecting the roaming destination AP, the roaming management logic 410A may be configured to establish an association with the roaming destination AP. In order to establish the association with the roaming destination AP, the roaming management logic 410A may be configured to send the authentication request and/or the association request to the roaming destination AP. Upon receiving the authentication request and/or the association request, the roaming destination AP may allow the client device 402 to join the network associated with the roaming destination AP. Further, upon associating with the roaming destination AP, the roaming management logic 410A may be configured to disassociate the client device 402 from the roaming source AP 404. In an example, to disassociate the client device 402 from the roaming source AP 404, the roaming management logic 410A may send, to the roaming source AP 404, a disassociation frame indicating a request for disassociating the client device 402 from the network associated with the roaming source AP 404. Upon receiving the disassociation frame, the roaming source AP 404 may terminate the connection with the client device 402.

In this way, the roaming management logic (e.g., the roaming management logics 410A and/or 410B) may configure the client device 402 to select and connect to the roaming destination AP. In an example, the roaming destination AP may be the next optimal AP that ensures that the client device 402 maintains a stable connection with the network (such as the Internet) while the client device 402 attempts to move out of the cell 408. As a result, the client device 402 may not suffer from connection failures (or connection delays) while roaming from one physical area serviced by one AP to another physical area serviced by another AP. Therefore, enabling client devices (such as the client device 402) to seamlessly roam across the network by suppressing the connection failures of the client device 402.

Although a specific embodiment of the conceptual network diagram 400 for carrying out the various steps, processes, methods, and operations described herein is discussed with respect to FIG. 4, any of a variety of systems and/or processes may be utilized in accordance with embodiments of the disclosure. For example, the conceptual network diagram 400 may include multiple client devices (similar to the client device 402), where each client device may individually execute the roaming management logic 410A described herein to select and connect to the next optimal AP. The elements depicted in FIG. 4 may also be interchangeable with other elements of FIGS. 1-3 and 5-10 as required to realize a particularly desired embodiment.

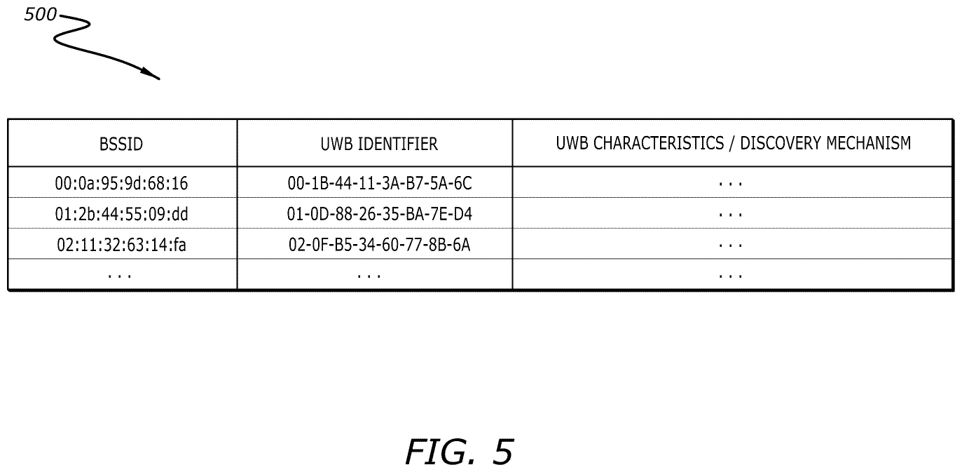

Referring to FIG. 5, an action frame 500 received by a client device in accordance with various embodiments of the disclosure is shown. In various embodiments, the action frame 500 may be received by the client device from a roaming source AP to which the client device is currently associated. The action frame 500 may be configured to indicate the UWB validation for a plurality of neighboring APs of the roaming source AP. Specifically, the action frame 500 may include one or more IEs along a plurality of rows, where each row corresponds to a respective neighboring AP of the plurality of neighboring APs. In the embodiments shown in FIG. 5, the action frame 500 may include a connectivity IE, a UWB IE, a UWB characteristic IE, and/or a UWB characteristic discovery mechanism IE along each row of the plurality of rows.

In many embodiments, the connectivity IE may indicate a BSSID of an AP. In an example, the BSSID of the AP may include a MAC address of a Wi-Fi interface of the AP. In many further embodiments, the connectivity IE may indicate an SSID of the AP. In an example, the SSID of the AP may include a network name of the AP.

In numerous embodiments, the UWB IE may indicate a UWB identifier of the AP. In an example, the UWB identifier may include a MAC address of a UWB interface of the AP. In numerous more embodiments, the UWB IE may indicate a UWB identifier of a UWB device connected to the AP. In these embodiments, the UWB identifier may include a MAC address of the UWB device.

In more embodiments, the UWB characteristic IE may indicate a set of UWB characteristics of the AP. In an example, the set of UWB characteristics of the AP may include a UWB channel supported by the AP, a UWB modulation scheme used by the AP, or the like. In some more embodiments, the action frame 500 may include the UWB characteristic discovery mechanism IE as an alternate to (or in addition to) the UWB characteristic IE. In an example, the UWB characteristic discovery mechanism IE may indicate at least one mechanism to discover the set of UWB characteristics of the AP. For example, the at least one mechanism may include a probing mechanism, an ANQP-based querying mechanism, or the like.

Although a specific embodiment of the action frame 500 for carrying out the various steps, processes, methods, and operations described herein is discussed with respect to FIG. 5, any of a variety of systems and/or processes may be utilized in accordance with embodiments of the disclosure. For example, the action frame 500 may only include connectivity IEs and UWB IEs. In other words, the action frame 500 may not include UWB characteristic IEs and/or UWB characteristic discovery mechanism IEs. The elements depicted in FIG. 5 may also be interchangeable with other elements of FIGS. 1-4 and 6-10 as required to realize a particularly desired embodiment.

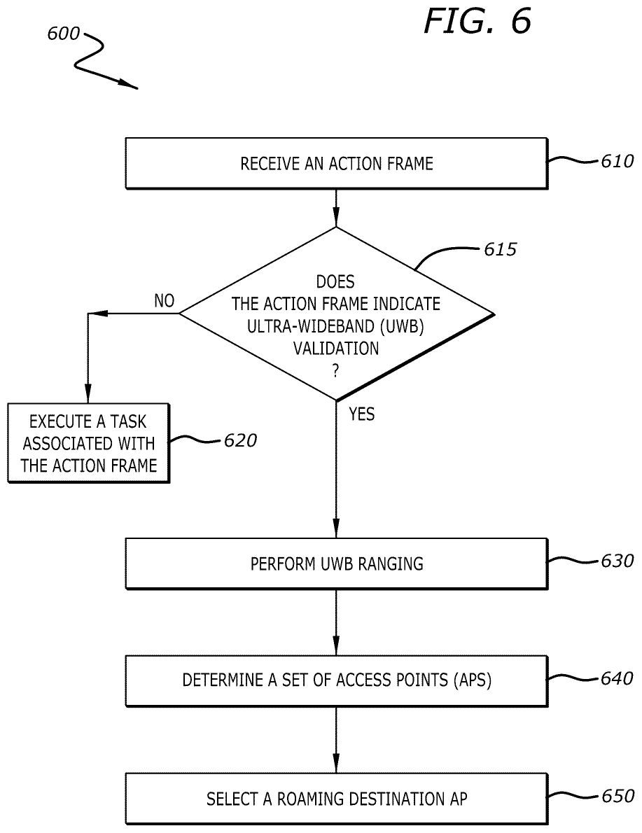

Referring to FIG. 6, a flowchart depicting a process 600 for selecting a roaming destination AP in accordance with various embodiments of the disclosure is shown. In more embodiments, the process 600 may receive an action frame from a roaming source AP (block 610). In an example, the action frame may be received by a client device that is currently connected to the roaming source AP. In some more embodiments, the action frame may be received by the client device by transmitting a roaming assistance request message to the roaming source AP. In an example, the roaming assistance request message may include an IE indicating support for a roaming assistant technology (e.g., a UWB technology supported by the client device). For example, the roaming assistance request message may include at least one of a BTM query defined in the 802.11v standard or a neighbor report request defined in the 802.11k standard. In yet more embodiments, in response to transmitting the roaming assistance request message to the roaming source AP, the client device may receive the action frame from the roaming source AP. In an example, the action frame may be configured to indicate UWB validation. For example, the action frame may include one or more IEs indicating one or more identifiers of each of one or more neighboring APs of the roaming source AP.

In still more embodiments, the one or more IEs may include at least one of a connectivity IE or a UWB IE. The connectivity IE may indicate a BSSID of the neighboring AP (e.g., a MAC address of a Wi-Fi interface of the neighboring AP), a SSID of the neighboring AP (e.g., a network name of the neighboring AP), or the like. The UWB IE may indicate a UWB identifier of the neighboring AP (e.g., a MAC address of a UWB interface of the neighboring AP) or a UWB identifier of a UWB device connected to the neighboring AP. In still yet more embodiments, the action frame may further include a UWB characteristic IE or a UWB characteristic discovery mechanism IE of each of the one or more neighboring APs. The UWB characteristic IE may indicate a set of UWB characteristics of the neighboring AP. In an example, the set of UWB characteristics of the neighboring AP may include a UWB channel supported by the neighboring AP, a UWB modulation scheme used by the neighboring AP, or the like. The UWB characteristic discovery mechanism IE may indicate at least one mechanism to discover the set of UWB characteristics of the neighboring AP. In an example, the at least one mechanism may include a probing mechanism, an ANQP-based querying mechanism, or the like.

In a variety of embodiments, the process 600 may determine whether the action frame indicates the UWB validation (block 615). In an example, upon receiving the action frame, the client device may determine whether the action frame indicates the UWB validation. Specifically, the client device may determine whether the action frame includes one or more UWB IEs in order to determine whether the action frame indicates the UWB validation. In an example, if the action frame does not include one or more UWB IEs, the client device may determine that the action frame does not indicate the UWB validation. Conversely, if the action frame includes one or more UWB IEs, the client device may determine that the action frame indicates the UWB validation.

In numerous embodiments, if the action frame does not indicate the UWB validation, the process 600 may execute a task associated with the action frame (block 620). The task can be any task that the AP wants the client device to execute. In numerous more embodiments, in addition to the action frame indicating the UWB validation, the client device may receive an action frame configured to indicate a radio measurement request, an action frame configured to indicate a change in an operating channel of the roaming source AP, or the like. Upon receiving the action frame indicating the radio measurement request, the client device may measure specific metrics defined in the action frame and forward the measured metrics to the roaming source AP. Upon receiving the action frame indicating the change in the operating channel of the roaming source AP, the client device may switch to a new operating channel indicated by the action frame.

In many embodiments, if the action frame indicates the UWB validation, the process 600 may perform UWB ranging to the one or more neighboring APs based on the action frame (block 630). For example, the UWB ranging may be performed by the client device based on the action frame. In an example, to perform the UWB ranging, the client device may identify the neighboring APs that support the UWB technology based on the UWB IEs included in the action frame.

In many further embodiments, upon identifying the neighboring APs that support the UWB technology, the client device may perform the UWB ranging to the neighboring APs based on a TDoA method. In an example, based on the TDoA method, the client device may transmit a UWB signal to the neighboring APs and determine the location of the client device by measuring the difference in arrival times of the UWB signal at the neighboring APs. Additionally, the client device may perform, based on the TDoA method, the UWB ranging two or more times to determine a movement path of the client device. In an example, the movement path may correspond to a sequence of locations traversed by the client device over time.

In many additional embodiments, upon identifying the neighboring APs that support the UWB technology, the client device may perform the UWB ranging to the neighboring APs by utilizing a radar function associated with the UWB function supported by the client device. In an example, by utilizing the radar function, the client device may transmit a UWB signal to each of the neighboring APs and receive a reflected UWB signal from each of the neighboring APs. Further, the client device may determine a Time of Flight (ToF) associated with each of the neighboring APs based on the transmission of the UWB signal and the reception of the reflected UWB signal and determine a LoS/nLoS status of each of the neighboring APs based on the determined ToF. In an example, the LoS/nLoS status of an AP of the neighboring APs may indicate whether the AP is in the LoS of the client device or not. Additionally, the client device may perform, by utilizing the radar function, the UWB ranging two or more times to determine a stability status of the LoS/nLoS status. In an example, the stability status of the LoS/nLoS status may indicate whether the LoS/nLoS status is stable or not.

In further embodiments, the process 600 may determine, based on the UWB ranging, a set of APs from the neighboring APs towards which the client device is moving (block 640). In an example, the set of APs may be determined by the client device. Specifically, the client device may determine the set of APs based on one or more results of the UWB ranging. For example, the one or more results of the UWB ranging may include one or more identifiers of the neighboring APs with which the client device performed the UWB ranging, the movement path of the client device, the LoS/nLoS statuses of the neighboring APs, and/or the stability statuses of the LoS/nLoS statuses.

In still further embodiments, in order to determine the set of APs, the client device may receive a roaming assistance response message from the roaming source AP based on the transmission of the roaming assistance request message. In an example, the roaming assistance response message may include one or more connectivity IEs indicating one or more identifiers of the neighboring APs. Further, the client device may cross-validate the one or more results of the UWB ranging with the one or more connectivity IEs. Specifically, in the cross-validation, the client device may determine a set of matching APs between the one or more results of the UWB ranging and the roaming assistance response message.

In still yet further embodiments, in order to determine the set of APs, the client device may perform scanning to identify the neighboring APs of the roaming source AP. In an example, the scanning may correspond to active scanning where the client device sends probe requests to identify the neighboring APs, passive scanning where the client device listens for beacon frames sent by the neighboring APs, or the like. Further, the client device may perform the cross-validation to determine the set of matching APs between the identified neighboring APs and the neighboring APs with which the client device performed the UWB ranging.

In further additional embodiments, the client device may determine, from the set of matching APs, the set of APs towards which the client device is moving. In an example, the set of APs may be determined from the set of matching APs based on the movement path of the client device. For example, the client device may determine, as the set of APs towards which the client device is moving, neighboring APs that are located ahead of the client device along the movement path. Additionally, or alternatively, the set of APs may be determined from the set of matching APs based on the stability status of the LoS/nLoS status of each of the one or more neighboring APs. For example, the client device may determine, as the set of APs towards which the client device is moving, neighboring APs having their stability statuses as a stable LoS.

In several embodiments, the process 600 may select a roaming destination AP from the set of APs (block 650). In an example, the roaming destination AP may be selected by the client device. For example, the selected roaming destination AP may correspond to the next optimal AP that ensures that the client device maintains a stable connection with the network (such as the Internet) while the client device attempts to move out of a physical area serviced by the roaming source AP. In order to select this roaming destination AP, the client device may determine at least one AP metric of each of the set of APs and select the roaming destination AP from the set of APs based on the determined at least one AP metric. In an example, the client device may determine, as the roaming destination AP, an AP whose at least one AP metric is above a threshold AP metric. Additionally, or alternatively, the client device may determine, as the roaming destination AP, an AP that has the highest at least one AP metric among the set of APs. In an example, the at least one AP metric of an AP of the set of APs may include a RSSI associated with the AP, a QBSS load associated with the AP, or the like. For example, the RSSI and/or the QBSS load associated with the AP may be determined based on probe responses or beacon responses received from the AP.

Although a specific embodiment for the process 600 for carrying out the various steps, processes, methods, and operations described herein is discussed with respect to FIG. 6, any of a variety of systems and/or processes may be utilized in accordance with embodiments of the disclosure. For example, upon selecting the roaming destination AP, the client device may establish an association with the roaming destination AP by sending an association request to the roaming destination AP. The elements depicted in FIG. 6 may also be interchangeable with other elements of FIGS. 1-5 and 7-10 as required to realize a particularly desired embodiment.

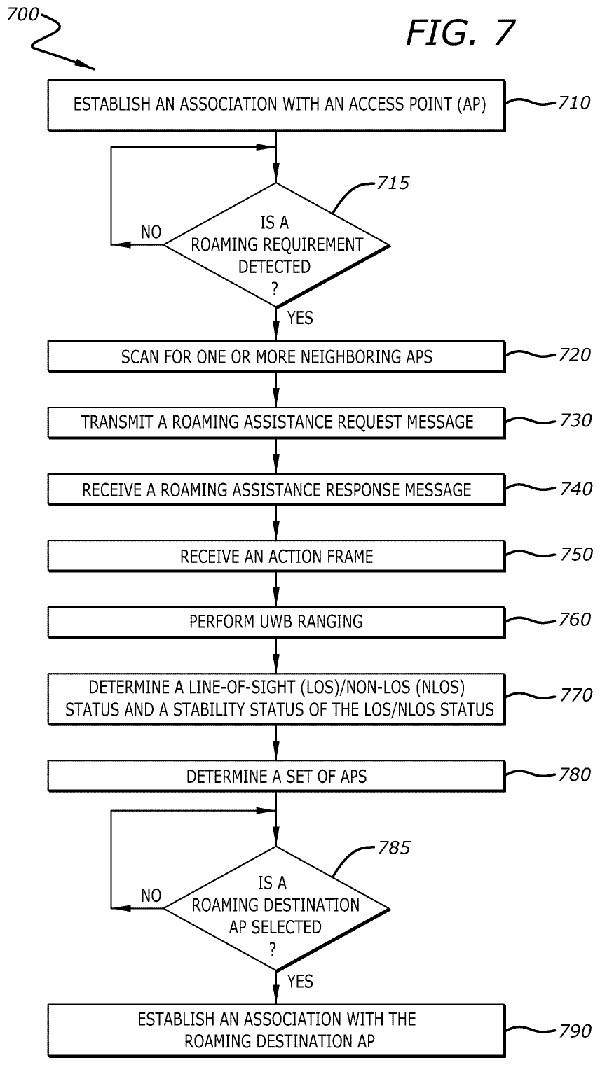

Referring to FIG. 7, a flowchart depicting a process 700 for establishing an association with a roaming destination AP in accordance with various embodiments of the disclosure is shown. In various embodiments, the process 700 may establish an association with an AP (block 710). In an example, a client device (e.g., a smartphone, a tablet, and/or a laptop/notebook) may establish an association with the AP. Specifically, the client device may establish the association with the AP if the client device is located within a physical area serviced by the AP, e.g., if the client device is in the vicinity of the AP. In order to establish the association with the AP, the client device may send an association request to the AP. In an example, the association request may indicate that the client device wants to be a part of a network associated with the AP. Upon receiving the association request, the AP may allow the client device to join the network. Thereby, the client device may be associated with the AP. Additionally, the client device and the AP may perform a handshake protocol (such as a 4-way Handshake protocol) to establish a secure connection between the client device and the AP.

In many embodiments, the process 700 may determine whether a roaming requirement is detected (block 715). In an example, the client device may determine whether the roaming requirement is detected. In order to detect the roaming requirement, the client device may measure one or more signal metrics (such as a RSSI value, a SNR value, or the like) associated with a wireless signal of the AP. Further, the client device may compare the measured signal metrics with a threshold signal metric to obtain a comparison result. If the comparison result indicates the measured signal metrics are below the threshold signal metric, the client device may determine that the roaming requirement is detected. Conversely, if the comparison result indicates the measured signal metrics are above or equal to the threshold signal metric, the client device may determine that the roaming requirement is not detected. In many further embodiments, if the roaming requirement is not detected, the process 700 may wait until the roaming requirement is detected by repeatedly performing the roaming requirement detection.

In many additional embodiments, if the roaming requirement is detected, the process 700 may scan for one or more neighboring APs of the AP (block 720). In an example, the scanning may be performed by the client device. For example, the scanning may correspond to active scanning where the client device sends probe requests to identify the neighboring APs, passive scanning where the client device listens for beacon frames sent by the neighboring APs, or the like.

In more embodiments, the process 700 may transmit a roaming assistance request message to the AP (block 730). In an example, the roaming assistance request message may be transmitted by the client device for requesting information regarding the neighboring APs of the AP. For example, the roaming assistance request message may include at least one of a BTM query defined in the 802.11v standard or a neighbor report request defined in the 802.11k standard. Upon receiving the roaming assistance request message, a roaming assistance response message that is configured to indicate the neighboring APs of the AP may be generated and transmitted by the AP. In an example, the roaming assistance response message may include one or more connectivity IEs indicating identifiers of the neighboring APs.

In still more embodiments, the roaming assistance request message may be configured to indicate support for a roaming assistant technology. In order to configure the roaming assistance request message to indicate the support for the roaming assistant technology, the client device may generate and add an IE indicating the support for the roaming assistant technology to the roaming assistance request message while generating the roaming assistance request message. In an example, the roaming assistant technology may include a UWB technology supported by the client device. Upon receiving the roaming assistance request message indicating the support for the roaming assistant technology, an action frame that is configured to UWB validation may be generated and transmitted by the AP. In an example, the action frame may include one or more UWB IEs indicating UWB identifiers of the neighboring APs.

In some more embodiments, the process 700 may receive the roaming assistance response message from the AP (block 740). In an example, the roaming assistance response message may be received by the client device based on the transmission of the roaming assistance request message. For example, the roaming assistance response message may correspond to at least one of a BTM request defined in 802.11v standard or a neighbor report defined in 802.11k standard.

In yet more embodiments, the process 700 may receive the action frame from the AP (block 750). In an example, the action frame may be received by the client device based on the transmission of the roaming assistance request message indicating the support for the roaming assistant technology. For example, the action frame may indicate the client device to perform UWB validation by including the one or more UWB IEs. The one or more UWB IEs may indicate the UWB identifiers of the neighboring APs (MAC address of UWB interfaces of the neighboring APs). In still yet more embodiments, the action frame may include a connectivity IE, a UWB characteristic IE, and/or a UWB characteristic discovery mechanism IE for each neighboring AP of the neighboring APs. The connectivity IE may indicate a BSSID of the neighboring AP (e.g., a MAC address of a Wi-Fi interface of the neighboring AP), a SSID of the neighboring AP (e.g., a network name of the neighboring AP), or the like. The UWB characteristic IE may indicate a set of UWB characteristics of the neighboring AP. In an example, the set of UWB characteristics of the neighboring AP may include a UWB channel supported by the neighboring AP, a UWB modulation scheme used by the neighboring AP, or the like. The UWB characteristic discovery mechanism IE may indicate at least one mechanism to discover the set of UWB characteristics of the neighboring AP. In an example, the at least one mechanism may include a probing mechanism, an ANQP-based querying mechanism, or the like.

In further embodiments, the process 700 may perform UWB ranging to the neighboring APs based on the action frame (block 760). In an example, the UWB ranging may be performed by the client device. In order to perform the UWB ranging, the client device may identify the neighboring APs that support the UWB technology based on the UWB IEs included in the action frame. Upon identifying the neighboring APs that support the UWB technology, the client device may perform the UWB ranging to the neighboring APs based on the set of UWB characteristics (e.g., the UWB channel, the UWB modulation scheme, or the like) of each of the neighboring APs. In a variety of embodiments, the client device may perform the UWB ranging to the neighboring APs based on a TDoA method. In an example, based on the TDoA method, the client device may transmit a UWB signal to the neighboring APs and determine the location of the client device by measuring the difference in arrival times of the UWB signal at the neighboring APs. Additionally, the client device may perform, based on the TDoA method, the UWB ranging two or more times to determine a movement path of the client device. In an example, the movement path may correspond to a sequence of locations traversed by the client device over time.

In still further embodiments, the process 700 may determine a LoS/nLoS status of each of the neighboring APs and a stability status of the LoS/nLoS status of each of the neighboring APs (block 770). In an example, the LoS/nLoS status and the stability status of the LoS/nLoS status may be determined by the client device. In order to determine the LoS/nLoS status of each of the neighboring APs, the client device may perform the UWB ranging to the neighboring APs by utilizing a radar function associated with the UWB function supported by the client device. In an example, by utilizing the radar function, the client device may transmit a UWB signal to each of the neighboring APs and receive a reflected UWB signal from each of the neighboring APs. Further, the client device may determine a Time of Flight (ToF) associated with each of the neighboring APs based on the transmission of the UWB signal and the reception of the reflected UWB signal and determine the LoS/nLoS status of each of the neighboring APs based on the determined ToF. In an example, the LoS/nLoS status of a particular neighboring AP may indicate whether the particular neighboring AP is in the LoS of the client device or not. For example, the client device may determine that the particular neighboring AP is in the LoS of the client device if the determined ToF associated with the particular neighboring AP is less than a threshold ToF. Conversely, if the determined ToF associated with the particular neighboring AP is greater than or equal to the threshold ToF, the client device may determine that the particular neighboring AP is not in the LoS of the client device.

In still yet further embodiments, to determine the stability status of the LoS/nLoS status of each of the neighboring APs, the client device may perform the UWB ranging two or more times by utilizing the radar function. In an example, the stability status of the LoS/nLoS status may indicate whether the LoS/nLoS status is stable or not. For example, the client device may determine the stability status of the LoS/nLoS status of a particular AP as a stable LoS or a stable nLoS, if the result of determining the LoS/nLoS status of the particular AP is consistent for a specific time duration. Conversely, the client device may determine the stability status of the LoS/nLoS status as an unstable LoS or an unstable nLoS, if the result of determining the LoS/nLoS status of the particular AP is not consistent.

In additional embodiments, the process 700 may determine a set of APs from the neighboring APs towards which the client device is moving (block 780). In an example, the set of APs may be determined by the client device. Specifically, the client device may determine the set of APs based on one or more results of the UWB ranging. For example, the one or more results of the UWB ranging may include one or more identifiers of the neighboring APs with which the client device performed the UWB ranging and/or the movement path of the client device.

In still additional embodiments, in order to determine the set of APs, the client device may cross-validate the one or more results of the UWB ranging with the information included in the received roaming assistance response message. In an example, the roaming assistance response message may include one or more connectivity IEs indicating identifiers of the neighboring APs. Specifically, in the cross-validation, the client device may determine a set of matching APs between the one or more results of the UWB ranging and the roaming assistance response message. Further, the client device may determine, from the set of matching APs, the set of APs based on the movement path of the client device. For example, the client device may determine, as the set of APs, neighboring APs that are located ahead of the client device along the movement path.

In still yet additional embodiments, in order to determine the set of APs, the client device may perform the cross-validation to determine the set of matching APs between the neighboring APs identified by performing the scanning and the neighboring APs with which the client device performed the UWB ranging. Further, the client device may determine, from the set of matching APs, the set of APs based on the movement path of the client device. Additionally, or alternatively, the client device may determine, from the set of matching APs, the set of APs based on the stability status of the LoS/nLoS status of each of the neighboring APs. For example, the client device may determine, as the set of APs, neighboring APs having their stability statuses as the stable LoS.

In further additional embodiments, the process 700 may determine whether the roaming destination AP is selected (block 785). In an example, the client device may determine whether the roaming destination AP is selected. In a variety of embodiments, the roaming destination AP may be selected from the set of APs towards which the client device is moving. In order to select the roaming destination AP, the client device may identify an AP from the set of APs and determine at least one AP metric associated with the identified AP. Further, the client device may determine the identified AP as the roaming destination AP if the at least one AP metric is above a threshold AP metric. Conversely, if the at least one AP metric is equal to or below the threshold AP metric, the client device may determine the identified AP as a non-roaming destination AP. In an example, the at least one AP metric may include a RSSI associated with the AP, a QBSS load associated with the AP, or the like. In several embodiments, if the identified AP is not selected as the roaming destination AP, the process 700 may repeat the roaming destination AP selection process by moving to the next AP in the set of APs (block 785).

However, in numerous embodiments, if the roaming destination AP is selected, the process 700 may establish an association with the roaming destination AP (block 790). In an example, the client device may establish the association with the roaming destination AP. In order to establish the association with the roaming destination AP, the client device may send an association request to the roaming destination AP. In an example, the association request may indicate that the client device wants to be a part of a network associated with the roaming destination AP. Upon receiving the association request, the roaming destination AP may allow the client device to join the network. Thereby, the client device may be associated with the roaming destination AP.

In this way, the process 700 may configure the client device to select and connect to the roaming destination AP. In an example, the roaming destination AP may be the next optimal AP that ensures the client device maintains a stable connection with the network (such as the Internet) while the client device attempts to move out of the physical area serviced by the currently connected AP. As a result, the client device may not suffer from connection failures (or connection delays) while roaming from one physical area serviced by one AP to another physical area serviced by another AP. Therefore, the process 700 enables the client device to seamlessly roam across the network.

Although a specific embodiment for the process 700 for carrying out the various steps, processes, methods, and operations described herein is discussed with respect to FIG. 7, any of a variety of systems and/or processes may be utilized in accordance with embodiments of the disclosure. For example, the process 700 may further configure the client device to disassociate from the AP by transmitting a disassociation frame to the AP. The elements depicted in FIG. 7 may also be interchangeable with other elements of FIGS. 1-6 and 8-10 as required to realize a particularly desired embodiment.

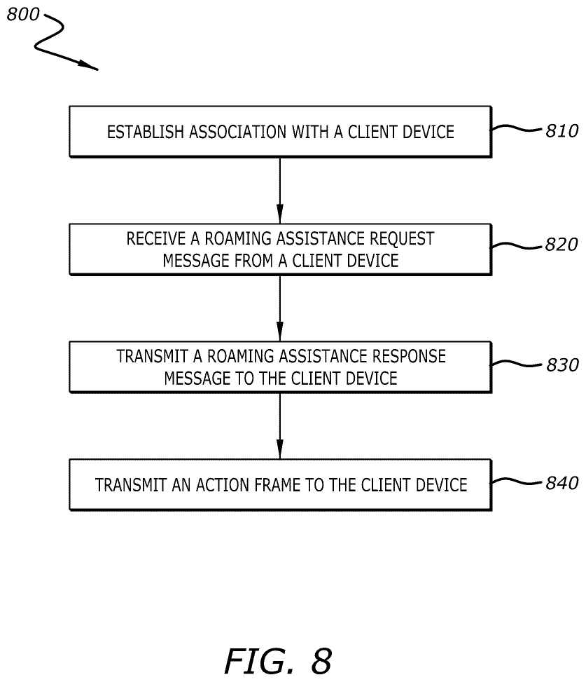

Referring to FIG. 8, a flowchart depicting a process 800 for transmitting an action frame in accordance with various embodiments of the disclosure is shown. In a variety of embodiments, the process 800 may establish an association with a client device (block 810). In an example, the association may be established between the client device and an AP that allows the client device to connect to a network (such as the Internet). For example, if the client device is in vicinity of the AP, an association request may be transmitted by the client device to the AP, where the association request may indicate that the client device requests to join the network. Upon receiving the association request, the AP may transmit an association response to the client device, where the association response indicates that the association is successful. Additionally, the AP and the client device may perform a handshake protocol (such as a 4-way Handshake protocol) to establish a secure connection between the AP and the client device.

In many embodiments, the process 800 may receive a roaming assistance request message from the client device (block 820). In an example, the roaming assistance request message may be received by the AP. In a number of embodiments, the roaming assistance request message may include a request for information regarding neighboring APs of the AP. For example, the roaming assistance request message may include at least one of a BTM query defined in the 802.11v standard or a neighbor report request defined in the 802.11k standard.

In many further embodiments, upon receiving the roaming assistance request message, the AP may generate a roaming assistance response message that is configured to indicate the neighboring APs of the AP. In an example, the roaming assistance response message may include one or more connectivity IEs indicating one or more identifiers of the neighboring APs. For example, an identifier of the neighboring AP may include a BSSID of the neighboring AP, an SSID of the neighboring, or the like.

In many additional embodiments, the received roaming assistance request message may be configured to indicate support for a roaming assistant technology. In an example, the roaming assistant technology may correspond to a UWB technology supported by the client device. Upon receiving the roaming assistance request message indicating the support for the roaming assistant technology, the AP may determine whether the neighboring APs support the same roaming assistant technology. If the neighboring APs support the roaming assistant technology, the AP may generate an action frame that is configured to indicate UWB validation. In order to configure the action frame to indicate the UWB validation, the AP may add one or more UWB IEs into the action frame while generating the action frame. For example, the one or more UWB IEs may indicate UWB identifiers of the neighboring APs. Additionally, the action frame may include the connectivity IEs.

In further embodiments, the process 800 may transmit the roaming assistance response message to the client device (block 830). In an example, the roaming assistance response message may be transmitted by the AP in response to the reception of the roaming assistance request message or the reception of the roaming assistance request message indicating the support for the roaming assistant technology. For example, the roaming assistance response message may correspond to at least one of a BTM request defined in 802.11v standard or a neighbor report defined in 802.11k standard.

In additional embodiments, the process 800 may transmit the action frame to the client device (block 840). For example, the action frame may be transmitted by the AP in response to the reception of the roaming assistance request message indicating the support for the roaming assistant technology. In an example, the action frame may be transmitted to the client device in order to assist the client device in performing UWB ranging to the neighboring APs which in turn enables the client device to select and connect to the next optimal AP among the neighboring APs.

Although a specific embodiment for the process 800 for carrying out the various steps, processes, methods, and operations described herein is discussed with respect to FIG. 8, any of a variety of systems and/or processes may be utilized in accordance with embodiments of the disclosure. For example, the process 800 may further configure the AP to transmit the action frame including a UWB characteristic IE (or a UWB characteristic discovery mechanism IE) for each of the neighboring APs. The elements depicted in FIG. 8 may also be interchangeable with other elements of FIGS. 1-7 and 9-10 as required to realize a particularly desired embodiment.

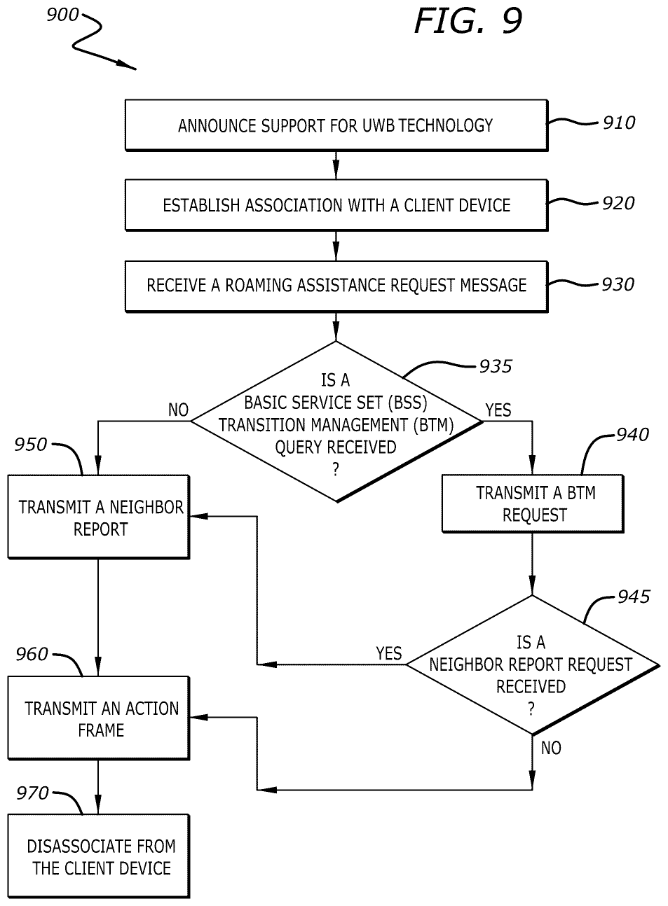

Referring to FIG. 9, a flowchart depicting a process 900 for disassociating from the client device in accordance with various embodiments of the disclosure is shown. In a variety of embodiments, the process 900 may announce support for UWB technology (block 910). In an example, the announcement of the support of the UWB technology may be performed by an AP. In order to announce the support for UWB technology, the AP may broadcast a beacon frame that indicates the presence of the UWB technology. One or more client devices may receive the beacon frame if the client devices are located in the vicinity of the AP (i.e., a physical area serviced by the AP). Upon receiving the beacon frame, the client device may forward an association request to the AP in order to establish an association with the AP.

In a number of embodiments, the process 900 may establish the association with the client device (block 920). In an example, the association may be established by the AP based on the association request. For example, the association request may indicate that the client device wants to be a part of a network associated with the AP. Upon receiving the association request, the AP may validate, using access control lists (ACLs) associated with the AP or the like, the association request to determine whether the client device is allowed to join the network. If the client device is allowed to join the network, the AP may associate with the client device and forward an association response to the client device. In an example, the association response may indicate that the association is successful.

In many embodiments, the process 900 may receive a roaming assistance request message from the client device (block 930). In an example, the roaming assistance request message may be received by the AP. The roaming assistance request message may include a request for information regarding neighboring APs of the AP. For example, the roaming assistance request message may include at least one of a BTM query defined in the 802.11v standard or a neighbor report request defined in the 802.11k standard.

In many further embodiments, the process 900 may determine whether the BTM query is received (block 935). In an example, the AP may determine whether the BTM query is received. For example, the AP may determine that the BTM query is received if the received assistance request message includes (or corresponds) to the BTM query. Conversely, if the received assistance request message does not include the BTM query, the AP may determine that the BTM query is not received.

In further embodiments, if the BTM query is received, the process 900 may transmit a BTM request to the client device (block 940). In an example, the BTM request may be transmitted by the AP. The BTM request may be configured to indicate the neighboring APs of the AP. In an example, the BTM request may include one or more connectivity IEs indicating identifiers (such as BSSIDs, SSIDS, or the like) of the neighboring APs.

In further additional embodiments, the process 900 may determine whether the neighbor report request is received (block 945). In an example, the AP may determine whether the neighbor report request is received. For example, the AP may determine that the neighbor report request is received if the received roaming assistance request message includes (or corresponds) to the neighbor report request. Conversely, if the received assistance request message does not include the neighbor report request, the AP may determine that the neighbor report request is not received.

In additional embodiments, if the neighbor report request is received or the BTM query is not received, the process 900 may transmit a neighbor report to the client device (block 950). In an example, the neighbor report may be transmitted by the AP. The neighbor report may be configured to indicate the neighboring APs of the AP. In an example, the neighbor report may include the connectivity IEs indicating the identifiers of the neighboring APs.

In still additional embodiments, if the neighbor report request is not received, the process 900 may transmit an action frame to the client device (block 960). In an example, the action frame may be transmitted by the AP. In still yet additional embodiments, the received roaming assistance request message may indicate the support for the UWB technology. Upon receiving the roaming assistance request message indicating the support for the UWB technology, the AP may generate and transmit the action frame that indicates UWB validation. In an example, the action frame may include one or more UWB IEs indicating UWB identifiers of the neighboring APs. Additionally, the action frame may include the connectivity IEs. For example, the AP may transmit the action frame to the client device for assisting the client device in performing UWB ranging with the neighboring APs which in turn enables the client device to select and connect to the next optimal AP among the neighboring APs.

In several embodiments, the process 900 may disassociate from the client device (block 970). In an example, upon connecting to the next optimal AP, the client device may transmit a disassociation frame to the AP. The disassociation frame may indicate a request for disassociating the client device from the network associated with the AP. Upon receiving the disassociation frame, the AP may disassociate from the client device by terminating the connection with the client device.

Although a specific embodiment for the process 900 for carrying out the various steps, processes, methods, and operations described herein is discussed with respect to FIG. 9, any of a variety of systems and/or processes may be utilized in accordance with embodiments of the disclosure. For example, the process 900 may further configure the AP to transmit one or more additional action frames. In an example, the additional action frames may include an action frame indicating a radio measurement request, an action frame indicating a change in an operating channel of the AP, or the like. The elements depicted in FIG. 9 may also be interchangeable with other elements of FIGS. 1-8 and 10 as required to realize a particularly desired embodiment.

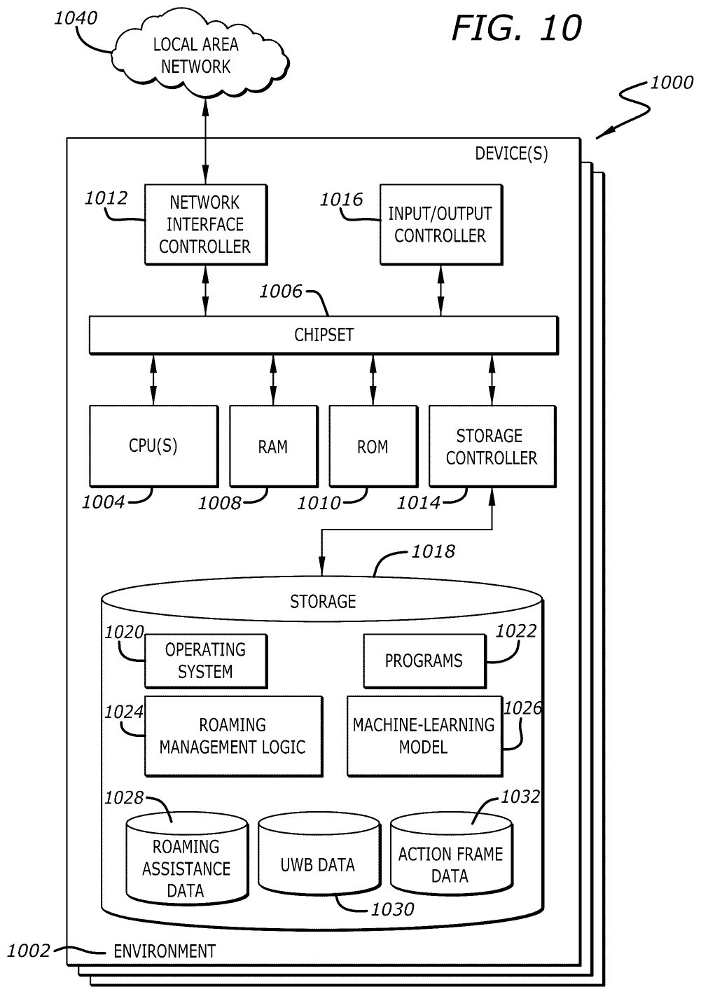

Referring to FIG. 10, a conceptual block diagram of a device 1000 suitable for configuration with a roaming management logic in accordance with various embodiments of the disclosure is shown. The embodiment of the conceptual block diagram depicted in FIG. 10 can illustrate a conventional server, computer, workstation, desktop computer, laptop, tablet, network appliance, e-reader, smartphone, or other computing device, and can be utilized to execute any of the application or logic components presented herein. The embodiment of the conceptual block diagram depicted in FIG. 10 can also illustrate an access point, a switch, or a router in accordance with various embodiments of the disclosure. The device 1000 may, in many non-limiting examples, correspond to physical devices or to virtual resources described herein.

In many embodiments, the device 1000 (e.g., a network device or a client device) may include an environment 1002 such as a baseboard or “motherboard,” in physical embodiments that can be configured as a printed circuit board with a multitude of components or devices connected by way of a system bus or other electrical communication paths. Conceptually, in virtualized embodiments, the environment 1002 may be a virtual environment that encompasses and executes the remaining components and resources of the device 1000. In more embodiments, one or more processors 1004, such as, but not limited to, central processing units (“CPUs”) can be configured to operate in conjunction with a chipset 1006. The processor(s) 1004 can be standard programmable CPUs that perform arithmetic and logical operations necessary for the operation of the device 1000.

In a number of embodiments, the processor(s) 1004 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 1006 may provide an interface between the processor(s) 1004 and the remainder of the components and devices within the environment 1002. The chipset 1006 can provide an interface to a random-access memory (“RAM”) 1008, which can be used as the main memory in the device 1000 in some embodiments. The chipset 1006 can further be configured to provide an interface to a computer-readable storage medium such as a read-only memory (“ROM”) 1010 or non-volatile RAM (“NVRAM”) for storing basic routines that can help with various tasks such as, but not limited to, starting up the device 1000 or transferring information between the various components and devices. The ROM 1010 or NVRAM can also store other application components necessary for the operation of the device 1000 in accordance with various embodiments described herein.

Additional embodiments of the device 1000 can be configured to operate in a networked environment using logical connections to remote computing devices and computer systems through a network, such as the network 1040. The chipset 1006 can include functionality for providing network connectivity through a network interface card (“NIC”) 1012, which may comprise a gigabit Ethernet adapter or similar component. The NIC 1012 can be capable of connecting the device 1000 to other devices over the network 1040. It is contemplated that multiple NICs 1012 may be present in the device 1000, connecting the device to other types of networks and remote systems.

In further embodiments, the device 1000 can be connected to a storage 1018 that provides non-volatile storage for data accessible by the device 1000. The storage 1018 can, for instance, store an operating system 1020, applications 1022, roaming assistance data 1028, UWB data 1030, and action frame data 1032 which are described in greater detail below. The storage 1018 can be connected to the environment 1002 through a storage controller 1014 connected to the chipset 1006. In certain embodiments, the storage 1018 can consist of one or more physical storage units. The storage controller 1014 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 1000 can store data within the storage 1018 by transforming the physical state of the physical storage units to reflect the information being stored. The specific transformation of physical state can depend on various factors. Examples of such factors can include, but are not limited to, the technology used to implement the physical storage units, whether the storage 1018 is characterized as primary or secondary storage, and the like.

In still more embodiments, the device 1000 can store information within the storage 1018 by issuing instructions through the storage controller 1014 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 1000 can further read or access information from the storage 1018 by detecting the physical states or characteristics of one or more particular locations within the physical storage units.

In addition to the storage 1018 described above, the device 1000 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 1000. In some examples, the operations performed by a cloud computing network, and or any components included therein, may be supported by one or more devices similar to device 1000. Stated otherwise, some or all of the operations performed by the cloud computing network, and or any components included therein, may be performed by one or more devices 1000 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CDROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 1018 can store an operating system 1020 utilized to control the operation of the device 1000. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 1018 can store other system or application programs and data utilized by the device 1000.

In many additional embodiments, the storage 1018 or other computer-readable storage media is encoded with computer-executable instructions which, when loaded into the device 1000, may transform it from a general-purpose computing system into a special-purpose computer capable of implementing the embodiments described herein. These computer-executable instructions may be stored as application 1022 and transform the device 1000 by specifying how the processor(s) 1004 can transition between states, as described above. In some embodiments, the device 1000 has access to computer-readable storage media storing computer-executable instructions which, when executed by the device 1000, perform the various processes described above with regard to FIGS. 1-9. In certain embodiments, the device 1000 can also include computer-readable storage media having instructions stored thereupon for performing any of the other computer-implemented operations described herein.

In many further embodiments, the device 1000 may include a roaming management logic 1024. The roaming management logic 1024 can be configured to perform one or more of the various steps, processes, operations, or other methods that are described above. Often, the roaming management logic 1024 can be a set of instructions stored within a non-volatile memory that, when executed by the processor(s) 1004 can carry out these steps, etc. In some embodiments, the roaming management logic 1024 may be a client application that resides on a network-connected device, such as, but not limited to, a server, switch, personal or mobile computing device in a single or distributed arrangement.

Various embodiments are based on the recognition that transmission of a BTM request or neighbor report to a client device may assist the client device in selecting the next optimal AP while the client device performs roaming. In an example, the BTM request or neighbor report may indicate a list of neighboring APs, among which one could potentially be the next optimal AP. Some more embodiments are based on the realization that the reception of the BTM request or neighbor report alone is insufficient in selecting the next optimal AP, because the list of neighboring APs may also include an AP located behind a moving user or on a lower floor. To this end, in numerous embodiments, when the device 1000 is configured as the network device, the roaming management logic 1024 may be configured to generate and transmit an action frame (e.g., an enhanced BTM request or an enhanced neighbor report) to the client device. In an example, the action frame may include connectivity IEs indicating identifiers of the neighboring APs and UWB IEs indicating UWB identifiers of the neighboring APs. The action frame may assist the client device in validating the BTM request or neighbor report for selecting the next optimal AP.

In numerous more embodiments, when the device 1000 is configured as the client device, the roaming management logic 1024 may be configured to receive and utilize the action frame to perform UWB ranging to the neighboring APs in order to select the next optimal AP that ensures that the client device maintains a stable connection with the network (such as the Internet). As a result, the client device may not suffer from connection failures (or connection delays) while the client device performs the roaming. Thus, enabling the client device to perform seamless roaming by suppressing the connection failures of the client device.

In numerous additional embodiments, the roaming assistance data 1028 may include a roaming assistance request message and/or a roaming assistance response message. The roaming assistance request message may indicate a request for information regarding the neighboring APs. For example, the roaming assistance request message may include at least one of a BTM query or a neighbor report request. The roaming assistance response message may indicate the neighboring APs. For example, the roaming assistance response message may include at least one of the BTM request or the neighbor report.

In a variety of embodiments, the UWB data 1030 may include a UWB identifier of the device 1000, a UWB identifier of a UWB device connected to the device 1000, a set of UWB characteristics of the device 1000, and/or a UWB characteristic discovery mechanism of the device 1000. For example, the UWB identifier of the device 1000 (or the UWB device) may correspond to a MAC address of a UWB interface of the device 1000 (or the UWB device). The set of UWB characteristics may include a UWB channel supported by the device 1000, a UWB modulation scheme used by the device 1000, or the like. The UWB characteristic discovery mechanism may indicate a mechanism (such as a probing mechanism or a ANQP-based querying mechanism) that the device 1000 uses to convey its set of UWB characteristics.

In various further embodiments, the action frame data 1032 may include one or more connectivity IEs and/or UWB IEs. For example, the connectivity IEs may indicate identifiers (such as BSSIDs, SSIDs, or the like) of the neighboring APs. The UWB IEs indicate UWB identifiers of the neighboring APs. Additionally, the action frame data 1032 may include a UWB characteristic IE or a UWB characteristic discovery mechanism IE of each of the neighboring APs. In an example, the UWB characteristic IE of the neighboring AP may indicate the set of UWB characteristics of the neighboring AP. The UWB characteristic discovery mechanism IE of the neighboring AP may indicate the UWB characteristic discovery mechanism of the neighboring AP.

In still further embodiments, the device 1000 can also include one or more input/output controllers 1016 for receiving and processing input from a number of input devices, such as a keyboard, a mouse, a touchpad, a touch screen, an electronic stylus, or other type of input device. Similarly, an input/output controller 1016 can be configured to provide output to a display, such as a computer monitor, a flat panel display, a digital projector, a printer, or other type of output device. Those skilled in the art will recognize that the device 1000 might not include all of the components shown in FIG. 10 and can include other components that are not explicitly shown in FIG. 10 or might utilize an architecture completely different than that shown in FIG. 10.

Finally, in numerous additional embodiments, data may be processed into a format usable by a machine-learning model 1026 (e.g., feature vectors), and or other pre-processing techniques. The machine-learning (“ML”) model 1026 may be any type of ML model, such as supervised models, reinforcement models, or unsupervised models. The ML model 1026 may include one or more of linear regression models, logistic regression models, decision trees, Naïve Bayes models, neural networks, k-means cluster models, random forest models, or other types of ML models 1026.

The ML model(s) 1026 can be configured to generate inferences to make predictions or draw conclusions from data. An inference can be considered the output of a process of applying a model to new data. This can occur by learning from at least the roaming assistance data 1028, the UWB data 1030, and the action frame data 1032 and using that learning to predict future outcomes. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 1026 may be generated by human/administrator verifications or may compare predicted outcomes with actual outcomes. Further, the ML model(s) 1026 may be utilized to select a roaming destination AP corresponding to the next optimal AP based on a set of APs determined by utilizing one or more of the roaming assistance data 1028, the UWB data 1030, or the action frame data 1032.

Although a specific embodiment for a device 1000 suitable for configuration with the roaming management logic for carrying out the various steps, processes, methods, and operations described herein is discussed with respect to FIG. 10, any of a variety of systems and/or processes may be utilized in accordance with embodiments of the disclosure. For example, the device 1000 may correspond to a mobile computing device such as a laptop (or a smartphone), or may correspond to a network device such as an AP. The elements depicted in FIG. 10 may also be interchangeable with other elements of FIGS. 1-9 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A client device, comprising:
a processor; and
a memory communicatively coupled to the processor, wherein the memory comprises a roaming management logic that is configured to:
receive an action frame configured to indicate Ultra-Wideband (UWB) validation;
perform UWB ranging to one or more access points (APs) based on the action frame;
determine a set of APs from the one or more APs based on the UWB ranging, wherein the set of APs is located ahead of the client device along a movement path of the client device; and
select a roaming destination AP based on the determined set of APs.

2. The client device of claim 1, wherein the action frame is received from a roaming source AP currently associated with the client device.

3. The client device of claim 2, wherein the roaming management logic is further configured to:
transmit a roaming assistance request message to the roaming source AP, wherein the roaming assistance request message is configured to indicate support for a roaming assistant technology, and wherein the action frame is based on the indication of support for the roaming assistant technology; and
receive a roaming assistance response message from the roaming source AP based on the transmitted roaming assistance request message, wherein the roaming assistance response message is configured to indicate one or more neighboring APs.

4. The client device of claim 3, wherein the roaming assistance request message comprises at least one of a basic service set (BSS) transition management (BTM) query or a neighbor report request, and the roaming assistance response message comprises at least one of a BTM request or a neighbor report.

5. The client device of claim 3, wherein determining the set of APs based on the UWB ranging comprises cross-validating one or more results of the UWB ranging against data from the roaming assistance response message.

6. The client device of claim 1, wherein the roaming management logic is further configured to scan for one or more neighboring APs.

7. The client device of claim 1, wherein the action frame comprises one or more identifiers of each of the one or more APs.

8. The client device of claim 7, wherein the one or more identifiers comprise at least one of a basic service set identifier (BSSID) or a UWB identifier.

9. The client device of claim 7, wherein the action frame further comprises an indication of a set of UWB characteristics for at least one of the one or more APs.

10. The client device of claim 7, wherein the action frame further comprises an indication of at least one mechanism to discover a set of UWB characteristics for at least one of the one or more APs.

11. The client device of claim 10, wherein the at least one mechanism comprises at least one of probing or access network query protocol (ANQP)-based querying.

12. The client device of claim 1, wherein the UWB ranging is based on a Time Difference of Arrival (TDoA).

13. The client device of claim 12, wherein the UWB ranging to at least one of the one or more APs is performed two or more times.

14. The client device of claim 12, wherein the roaming management logic is further configured to determine the movement path of the client device relative to each of the one or more APs based on the UWB ranging.

15. The client device of claim 1, wherein performing the UWB ranging comprises utilizing a UWB radar function.

16. The client device of claim 15, wherein the roaming management logic is further configured to determine a line-of-sight (LoS)/non-LoS (nLoS) status relative to the client device for each of the one or more APs based on the UWB ranging.

17. The client device of claim 16, wherein the roaming management logic is further configured to determine a stability status of the LoS/nLoS status for each of the one or more APs based on the UWB ranging.

18. The client device of claim 1, wherein the roaming destination AP is selected further based on at least one of a Received Signal Strength Indicator (RSSI) or a Quality of Service Basic Service Set (QBSS) load of at least one AP in the determined set of APs.

19. A network device, comprising:
a processor;
a network interface controller configured to provide access to a network; and
a memory communicatively coupled to the processor, wherein the memory comprises a roaming management logic that is configured to:
receive, from a client device, a roaming assistance request message is configured to indicate support for a roaming assistant technology; and
transmit to the client device:
a roaming assistance response message based on the received roaming assistance request message, wherein the roaming assistance response message is configured to indicate one or more neighboring devices of the network device, and
an action frame based on the indication of support for the roaming assistant technology, wherein the action frame is configured to indicate ultra-wideband (UWB) validation.

20. A method for managing roaming in a wireless network, the method comprising:
receiving an action frame indicating Ultra-Wideband (UWB) validation;
performing UWB ranging to one or more access points (APs) based on the action frame;
determining a set of APs from the one or more APs based on the UWB ranging, wherein the set of APs is located ahead of a client device along a movement path of the client device; and
selecting a roaming destination AP based on the determined set of APs.
